(19) United States
(12) Patent Application Publication
(10) Pub. No.: US 2026/0183822 A1
(43) Pub. Date: Jul. 2, 2026

(54) CLAMPING DEVICE AND FLARE FORMING TOOL

(71) Applicant: MAKITA CORPORATION, Anjo-shi (JP)

(72) Inventors: Toshihito YABUNAKA, Anjo-shi (JP); Yuya INOUE, Anjo-shi (JP)

(73) Assignee: MAKITA CORPORATION, Anjo-shi (JP)

(21) Appl. No.: 19/422,636

(22) Filed: Dec. 17, 2025

(30) Foreign Application Priority Data
Dec. 26, 2024 (JP) 2024-229810

(51) Int. Cl. B21D 41/02; B25B 5/04; B25B 5/12; B25B 5/14

(52) U.S. Cl. CPC B21D 41/026; B25B 5/04; B25B 5/12; B25B 5/147

(57) ABSTRACT

A clamping device that is configured to be mounted to a flare forming device is provided. The clamping device comprises: a body including a first body and a second body; a first connection part that connects the first body and the second body to rotate relative to each other; and an operating mechanism that is rotatably connected to the first body and the second body and configured to switch the first body and the second body, by utilizing a booster mechanism, between a closed position in which the first body and the second body are close to each other and form a clamp hole in the body, and an open position in which the first body and the second body are apart from each other.

### CROSS-REFERENCE TO RELATED APPLICATION

The present application claims priority to Japanese patent application No. 2024-229810 filed on December 26, 2024, the contents of which are fully incorporated herein by reference.

### TECHNICAL FIELD

The present disclosure relates to a clamping device and a flare forming tool.

### BACKGROUND

A clamping device for fixing a pipe to a flare forming device for forming a flare at an end of the pipe is known. For example, Japanese Patent No. 7350804 discloses a clamping device that forms a holding hole by closing a pair of openable/closable holding pieces. The holding pieces are biased in a direction of closing the holding pieces by a torsion spring, and a pipe placed in the holding hole is clamped by a biasing force of the torsion spring.

### SUMMARY

In the prior art, in order to place the pipe in the holding hole, the pair of holding pieces need to be separated from each other by applying a force against the torsion spring. Further in the prior art, the pipe is held by the biasing force of the torsion spring, so that the pipe may not be sufficiently fixed. Therefore, the pipe placed in the holding hole may be displaced before the clamping device is mounted to the flare forming device.

It is accordingly a non-limiting object of the present disclosure to provide a clamping device that firmly holds a pipe in a simple manner.

According to one non-limiting aspect of the present disclosure, a clamping device that is configured to be mounted to a flare forming device is provided. The clamping device comprises: a body including a first body and a second body; a first connection part that connects the first body and the second body to rotate relative to each other; and an operating mechanism that is rotatably connected to the first body and rotatably connected to the second body, and configured to switch the first body and the second body, by utilizing a booster mechanism, between a closed position in which the first body and the second body are close to each other and form a clamp hole in the body, and an open position in which the first body and the second body are apart from each other.

With the clamping device according to this aspect, a pipe is configured to be held in the clamp hole with a large force by a simple operation utilizing the booster mechanism.

According to another non-limiting aspect of the present disclosure, an electric flare forming tool is provided, including a flare forming device that forms a flare at an end of a pipe, and a clamping device according to the above-described aspect.

According to this aspect, a pipe can be held in the clamp hole with a large force by a simple operation utilizing the booster mechanism, so that the pipe can be restrained or prevented from being displaced before the clamping device is mounted to the flare forming device.

### BRIEF DESCRIPTION OF THE DRAWINGS

FIG. 1 is a perspective view of a flare forming tool according to a first embodiment.

FIG. 2 is a sectional view of the flare forming tool.

FIG. 3 is a sectional view of a flare forming device.

FIG. 4 is an explanatory view showing a front part of a clamping device in a closed position.

FIG. 5 is an explanatory view showing a back part of the clamping device in the closed position.

FIG. 6 is a perspective view of the clamping device in the closed position.

FIG. 7 is a perspective view of the clamping device in an open position.

FIG. 8 is an explanatory view showing a first groove of a first body.

FIG. 9 is a sectional view of the clamping device, which is taken along line IX-IX in FIG. 8.

FIG. 10 is a first explanatory view for showing how the clamping device is fixed to a clamp mounting part.

FIG. 11 is a second explanatory view for showing how the clamping device is fixed to the clamp mounting part.

FIG. 12 is a third explanatory view for showing how the clamping device is fixed to the clamp mounting part.

FIG. 13 is a fourth explanatory view for showing how the clamping device is fixed to the clamp mounting part.

FIG. 14 is a sectional view taken along line XIV-XIV in FIG. 13.

FIG. 15 is an explanatory view for showing how an operation part is operated.

FIG. 16 is a fifth explanatory view for showing how the clamping device is fitted to the clamp mounting part.

FIG. 17 is an explanatory view showing the clamp mounting part at a first rotation angle.

FIG. 18 is an exploded perspective view showing a connecting structure between a main housing and the clamp mounting part.

FIG. 19 is a sectional view taken along line XIX-XIX in FIG. 17.

FIG. 20 is a sectional view for showing how the clamp mounting part is disengaged from a rotation locking part.

FIG. 21 is an explanatory view showing the rotation locking part.

FIG. 22 is an explanatory view showing the clamp mounting part at a second rotation angle.

FIG. 23 is an explanatory view showing the clamp mounting part at a third rotation angle.

FIG. 24 is an explanatory view showing the clamp mounting part at a fourth rotation angle.

FIG. 25 is an explanatory view showing the clamp mounting part at a fifth rotation angle.

FIG. 26 is an explanatory view showing the clamp mounting part at a sixth rotation angle.

### DETAILED DESCRIPTION OF THE EMBODIMENTS

In one non-limiting embodiment according to the present disclosure, the first body may include a positioning pin that is configured to be engaged in a first engagement hole formed in the flare forming device. The positioning pin may be configured to be moved inside the first body to be switched between a protruding position in which the positioning pin protrudes outside of the first body and is configured to be engaged in the first engagement hole, and a housing position in which the positioning pin is housed in the first body.

According to this embodiment, the clamping device is fixed to the flare forming device with a simple structure of moving and engaging the positioning pin into the first engagement hole.

In addition or in the alternative to the preceding embodiments, the first body may further include a first facing part that faces the second body in the closed position, and a fixing pin that protrudes outside from the first facing part. The second body may include a second facing part that faces the first facing part in the closed position, and a second engagement hole that is formed in the second facing part and is configured to be engaged with the fixing pin in the closed position. The fixing pin may be integrated with the positioning pin.

According to this embodiment, the first body and the second body are easily aligned by provision of the fixing pin, and the number of parts of the clamping device is reduced by integrating the fixing pin and the positioning pin.

In addition or in the alternative to the preceding embodiments, the clamping device may further have a biasing member that biases the positioning pin toward the protruding position from the housing position. The positioning pin may be switched from the housing position to the protruding position and engaged in the first engagement hole by being biased by the biasing member when the clamping device is placed in a fixed position of the flare forming device. The clamping device may be fixed in the fixed position by the positioning pin engaged in the first engagement hole.

According to this embodiment, the positioning pin can be engaged in the first engagement hole without manually switching the position of the positioning pin, by utilizing the biasing force of the biasing member. Further, the positioning pin can be held in the protruding position by the biasing member. Therefore, the clamping device can be fixed in the fixed position of the flare forming device simply by the operation of placing the clamping device in the fixed position of the flare forming device.

In addition or in the alternative to the preceding embodiments, the clamping device may further have an operation part that is connected to the positioning pin and configured to move the positioning pin to be switched between the protruding position and the housing position.

According to this embodiment, the positioning pin can be switched between the protruding position and the housing position in a simple manner of operating the operation part, so that the clamping device is configured to be mounted to and removed from the flare forming device in a suitable manner.

In addition or in the alternative to the preceding embodiments, the operating mechanism may include: a first link that is connected to the first body to rotate; a second link that is connected to the second body to rotate; and a second connection part that connects the first link and the second link to rotate relative to each other. The booster mechanism may be a toggle mechanism including the first connection part, the first link, the second link and the second connection part.

According to this embodiment, by utilizing the toggle mechanism, the pipe can be held with a large force by a simple operation of operating the operating mechanism with a small force.

In addition or in the alternative to the preceding embodiments, at least one of the first body and the second body may have a linearly extending groove. The groove may be configured to be engaged with a guide rail provided on the flare forming device.

According to this embodiment, the clamping device is configured to be mounted to the flare forming device in a simple manner of engaging the groove and the guide rail.

In addition or in the alternative to the preceding embodiments, the first body may have the groove. The positioning pin may be provided in the groove of the first body. The positioning pin may be configured to be engaged in the first engagement hole formed in the guide rail of the flare forming device.

According to this embodiment, positioning of the clamping device relative to the flare forming device can be completed by engaging the groove of the first body with the guide rail of the flare forming device. Thus, the clamping device that is convenient to be mounted to the flare forming device is provided.

In addition or in the alternative to the preceding embodiments, the positioning pin may be configured to be switched between the protruding position and the housing position by moving inside the first body in a direction crossing an extending direction of the groove.

According to this embodiment, the clamping device is firmly held onto the flare forming device without being easily disengaged from the flare forming device.

### A. First Embodiment:

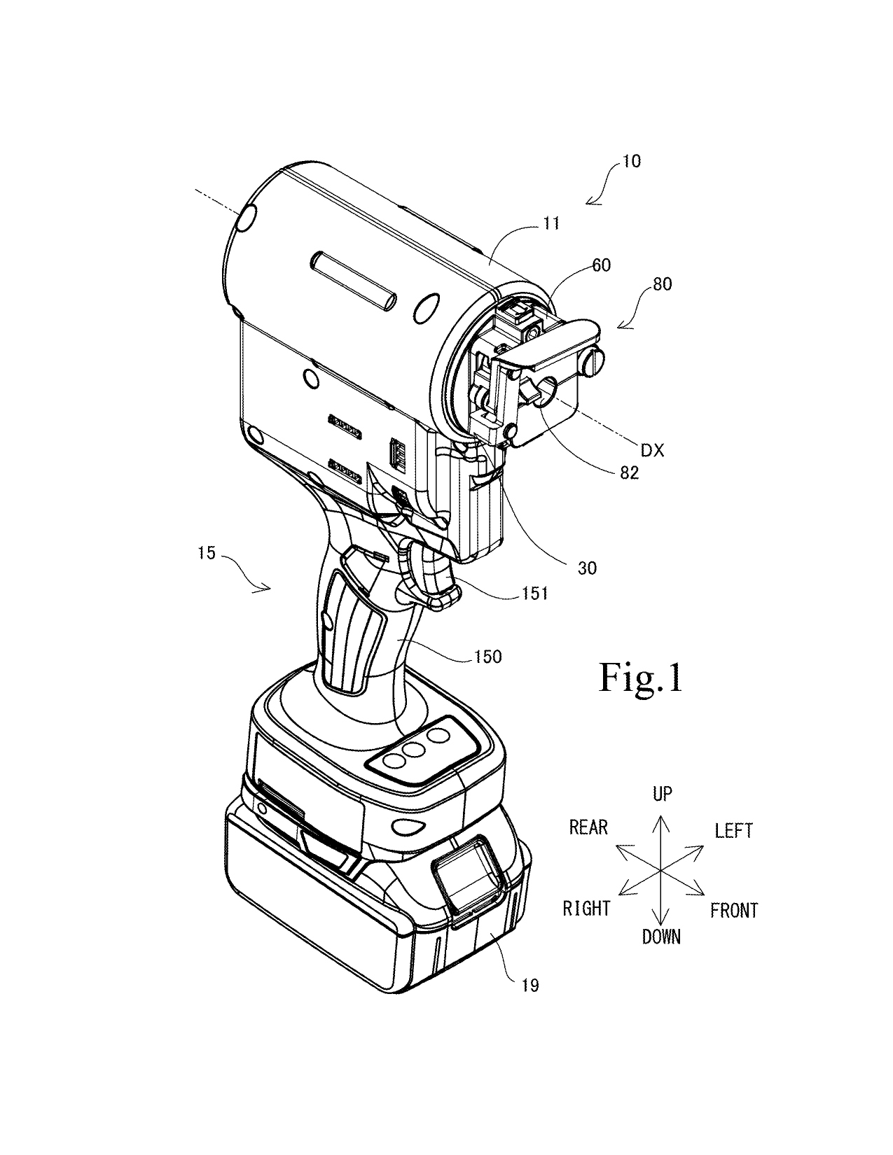

A flare forming tool 10 according to a first embodiment of the present disclosure is described. As shown in FIG. 1, the flare forming tool 10 is a power tool to be used to expand an end of a metal (typically, copper) pipe (tube) for a refrigerant into a conical shape in order to enable accurate connection of the pipe.

### A1. Structure of the Flare Forming Tool 10

As shown in FIG. 1, the flare forming tool 10 has a tool housing 11, and a flare forming device 30 including a clamping device 80. The tool housing 11 and a handle 15 form an outer shell of the flare forming tool 10.

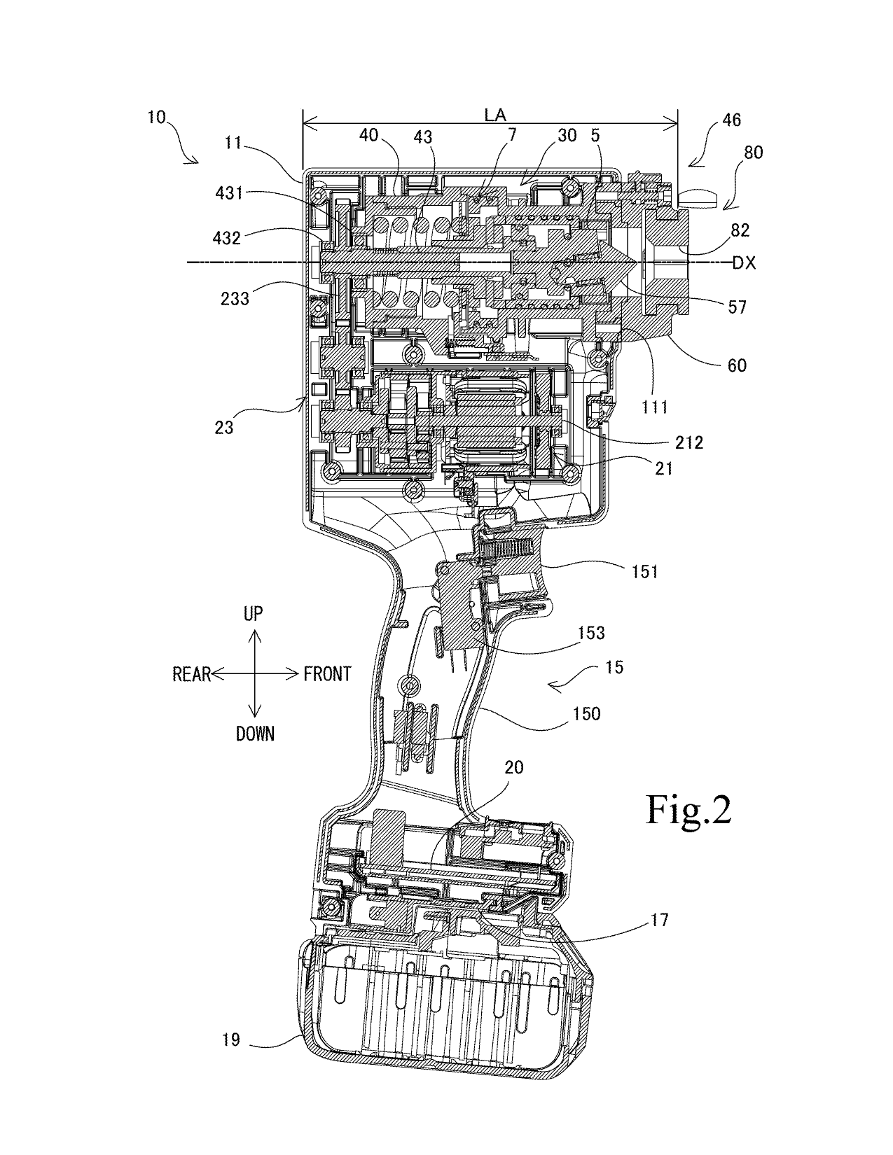

As shown in FIG. 2, the tool housing 11 extends along the driving axis DX of the flare forming device 30. The tool housing 11 houses an electric motor 21, a reduction mechanism 23 operably connected to the motor 21, and a flare forming device 30 operably connected to the reduction mechanism 23. An opening 111 is formed at an end of the tool housing 11. A clamp mounting part 60 is provided in a front end part of the flare forming device 30 and protrudes outside the opening 111. A clamping device 80 for clamping a pipe is mounted to the clamp mounting part 60.

The handle 15 protrudes from the tool housing 11 in a direction crossing (specifically, a direction substantially orthogonal to) the driving axis DX. The handle 15 includes a grip part 150 configured to be held by a user. The grip part 150 extends in a direction crossing (specifically, a direction substantially orthogonal to) the driving axis DX. The grip part 150 has a trigger 151 configured to be depressed by the user.

A switch 153 and a controller 20 are housed inside the handle 15. The switch 153 is housed in an upper part of the handle 15. The switch 153 is normally OFF, and is configured to be turned on in response to depressing of the trigger 151. The controller 20 is a control device configured to control operation of the flare forming tool 10.

A battery mounting part 17 is provided in a free end part of the handle 15. The flare forming tool 10 operates on power supplied from a battery 19 that is removably mounted to the battery mounting part 17. However, the flare forming tool 10 may also be configured to operate on power supplied from an external AC power source via a power cord.

When the user depresses the trigger 151 after the clamping device 80 clamping a pipe is mounted to the clamp mounting part 60 of the flare forming device 30, the switch 153 is turned on and the controller 20 drives the motor 21. When the motor 21 is driven, the flare forming device 30 is driven via the reduction mechanism 23, and a flare (a cone-shaped expanded part) is formed at the end of the pipe. In the following, the operation of forming a flare is also referred to simply as flaring operation.

In the following, for convenience of explanation, the extending direction of the driving axis DX is defined as a front-rear direction of the flare forming tool 10, the flare forming device 30 and the clamping device 80. In the front-rear direction, the side of the front end part (the clamp mounting part 60) of the flare forming device 30 is defined as the front side, and the opposite side is defined as the rear side. A direction orthogonal to the driving axis DX and corresponding to a longitudinal direction of the grip part 150 is defined as an up-down direction of the flare forming tool 10 and the flare forming device 30. In the up-down direction, the side of the free end of the handle 15 is defined as a lower side, and the opposite side is defined as an upper side. A direction orthogonal to the front-rear direction and the up-down direction is defined as a left-right direction of the flare forming tool 10 and the flare forming device 30. The directions of the clamping device 80 refer to the directions of the clamping device 80 mounted to the flare forming device 30 at a first rotation angle described below, unless otherwise specified.

As shown in FIG. 1, in this embodiment, the tool housing 11 is integrally formed with the handle 15. More specifically, two halves (a left shell and a right shell), each of which includes a portion forming the tool housing 11 and a portion forming the handle 15, are connected and fixed to each other in the left-right direction to form the integral tool housing 11. The tool housing 11 and the handle 15 may however be separately formed from each other and then connected and fixed to each other.

As shown in FIG. 2, the motor 21 is housed in a front half of a lower part of the tool housing 11. A rotational axis of an output shaft 212 of the motor 21 extends below and in parallel to the driving axis DX. The motor 21 is electrically connected to the controller 20 and controlled by the controller 20.

The reduction mechanism 23 is housed in a rear half of the lower part of the tool housing 11, behind the motor 21. The reduction mechanism 23 is a gear reduction mechanism including gears. The reduction mechanism 23 is operably connected to the output shaft 212 of the motor 21 and a main shaft 5 of the flare forming device 30 described below. The reduction mechanism 23 is configured to reduce the rotational speed of the output shaft 212 of the motor 21 and output it to the flare forming device 30. An output gear 233 of the reduction mechanism 23 is operably connected to the flare forming device 30. The rotational speed of the output shaft 212 of the motor 21 is reduced by a planetary gear and further reduced by a helical gear. The rotational speed of the output shaft 212 is thereafter outputted to the flare forming device 30 via the output gear 233.

The controller 20 is housed within a lower part of the handle 15. The controller 20 includes at least one processor (such as a CPU) or processing circuit, and is electrically connected to the motor 21 and the switch 153. In this embodiment, the controller 20 rotates the motor 21 in a normal direction while the trigger 151 is depressed and the switch 153 is turned on. When the trigger 151 is released and the switch 153 is turned off, the controller 20 stops rotation of the motor 21 and rotates the motor 21 in a reverse direction.

### A2. Structure of the Flare Forming Device 30

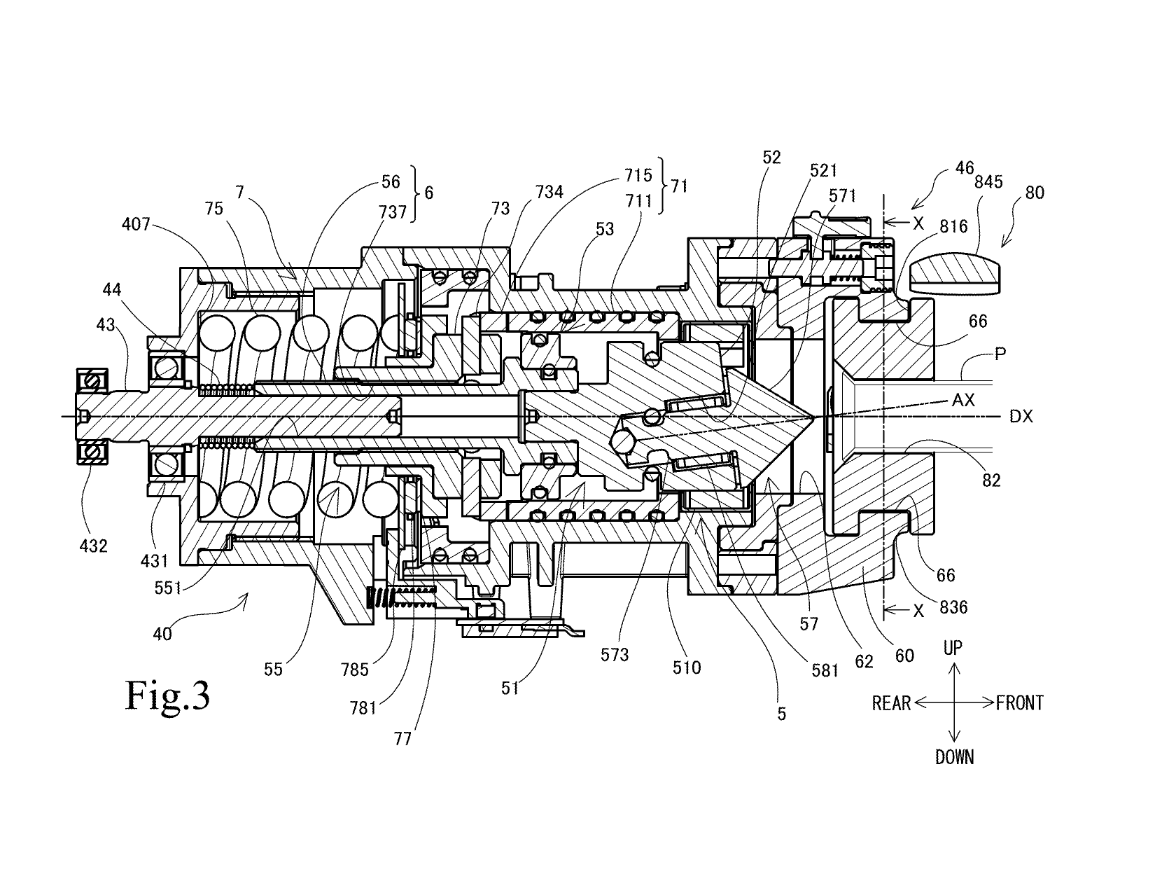

As shown in FIG. 2, the flare forming device 30 is arranged above the motor 21 within the tool housing 11. As shown in FIG. 3, the flare forming device 30 includes a housing 46 including a main housing 40 and the clamp mounting part 60, a transmission shaft 43, a main shaft 5, a cone 57 and a clutch mechanism 7. The transmission shaft 43, the main shaft 5, the cone 57 and the clutch mechanism 7 are housed in the main housing 40. The flare forming device 30 of this embodiment is configured as a single assembly in which these elements are connected to each other.

The main housing 40 has a generally circular cylindrical shape. The main housing 40 is arranged to extend in the front-rear direction along the driving axis DX. The main housing 40 is held within the tool housing 11 while being positioned in a prescribed position relative to the tool housing 11.

As shown in FIG. 2, a front end part of the main housing 40 protrudes forward of the tool housing 11 through the opening 111 of the tool housing 11. The front end part of the main housing 40 is configured as the clamp mounting part 60.

The transmission shaft 43 is operably connected to the output gear 233 of the reduction mechanism 23, and configured to transmit rotation of the output gear 233 to the main shaft 5. More specifically, the transmission shaft 43 is rotatably supported around the driving axis DX by the main housing 40 via two bearings 431, 432 that are arranged in a rear end part of the main housing 40. As shown in FIG. 2, a rear end part of the transmission shaft 43 is connected to the output gear 233 coaxially with the output gear 233, and the transmission shaft 43 rotates integrally with the output gear 233 when the motor 21 is driven.

As shown in FIG. 3, the main shaft 5 is a long member that defines the driving axis DX. The main shaft 5 may also be referred to as a spindle. The main shaft 5 can move in the front-rear direction along the driving axis DX while rotating around the driving axis DX, in the main housing 40. A front end part 52 of the main shaft 5 rotatably supports the cone 57 for forming a flare. As the main shaft 5 moves forward, the cone 57 protrudes forward from an opening 62 of the clamp mounting part 60 at a front end of the main housing 40.

The main shaft 5 includes a columnar sliding part 51 and a shaft part 55 extending rearward from a rear end of the sliding part 51.

The sliding part 51 forms a front half of the main shaft 5. The front end part 52 of the sliding part 51 rotatably supports the cone 57. The front end part 52 is supported by a bearing 510 so as to rotate around the driving axis DX and slide in the front-rear direction. A rear end part 53 of the sliding part 51 can slide along an inner surface of a first sleeve 711 of a fixed sleeve 71 arranged within the main housing 40.

The shaft part 55 forms a rear half of the main shaft 5. The shaft part 55 extends rearward from a central part of the sliding part 51. The shaft part 55 is hollow and has a connecting hole 551 having a polygonal section. A front half of the transmission shaft 43 is inserted into the connecting hole 551. With this configuration, the main shaft 5 can rotate integrally with the transmission shaft 43 and slide in the front-rear direction relative to the transmission shaft 43. A rear end part of the shaft part 55 is configured as a male thread part 56. The male thread part 56 can be threadedly engaged with a female thread part 737 of a movable flange 73 of the clutch mechanism 7.

As shown in FIG. 3, the cone 57 includes a conical cone part 571 and a cylindrical shaft part 573. The shaft part 573 is fitted into a radial bearing 581 within a support hole 521 of the rear end part 52. Thus, the cone 57 is supported to rotate around an axis AX by the front end part 52 of the main shaft 5. In this embodiment, the cone 57 is arranged such that its apex is always located on the driving axis DX. With this arrangement, a flare can be formed at an end of a thinner pipe than a structure in which the apex of the cone 57 is offset from the driving axis DX.

As shown in FIG. 3, the clutch mechanism 7 includes the fixed sleeve 71, the movable flange 73, a pressure spring 75 and a rotation stopper 77.

The fixed sleeve 71 is fitted into a front half of the main housing 40 and held so as not to substantially move relative to the main housing 40. In this embodiment, the fixed sleeve 71 is a single cylinder formed by connecting the first and second sleeves 711, 715 to each other in the front-rear direction.

The first sleeve 711 occupies most of the fixed sleeve 71. The rear end part 53 of the sliding part 51 of the main shaft 5 is slidably arranged within the first sleeve 711. The second sleeve 715 has a cylindrical shape shorter than the first sleeve 711 in the front-rear direction and has the same inner and outer diameters as the first sleeve 711.

The movable flange 73 is a cylindrical member (flange sleeve) with a flange. The movable flange 73 is arranged around the shaft part 55 of the main shaft 5 behind the second sleeve 715 of the fixed sleeve 71.

The female thread part 737 is formed on the inside of the shaft part 55 and configured to be threadedly engaged with the male thread part 56 of the main shaft 5. The male thread part 56 of the main shaft 5 and the female thread part 737 of the movable flange 73 form a feed screw mechanism 6 that moves the main shaft 5 and the movable flange 73 relative to each other in the front-rear direction. The male thread part 56 and the female thread part 737 correspond to a screw shaft and a nut of the feed screw mechanism 6, respectively. The feed screw mechanism 6 may be configured as a ball screw mechanism. In this case, balls are rollably arranged within a raceway that is defined by a spiral groove formed in an outer peripheral surface of the main shaft 5 and a spiral groove formed in an inner peripheral surface of the movable flange 73, and the main shaft 5 and the movable flange 73 are engaged via the balls.

As shown in FIG. 3, an auxiliary spring 44 is arranged between a rear end of the main shaft 5 and the bearing 431 within the rear end part of the main housing 40. The auxiliary spring 44 of this embodiment is a compression coil spring, and is arranged around the transmission shaft 43. The auxiliary spring 44 biases the main shaft 5 forward relative to the main housing 40. The auxiliary spring 44 holds the male thread part 56 in a position where it can be threadedly engaged with the female thread 737 when the male thread part 56 comes off the female thread part 737 due to rearward movement of the main shaft 5. The biasing force (load) of the auxiliary spring 44 is set to be significantly weaker (smaller) than the pressure spring 75.

As shown in FIG. 3, the pressure spring 75 is a metal compression coil spring, and is arranged behind the movable flange 73. A rear end of the pressure spring 75 abuts on a shoulder part 407 of the main housing 40. The pressure spring 75 biases the movable flange 73 forward toward the fixed sleeve 71 to press a clutch pin 734 onto the second sleeve 715. Thus, the movable flange 73 is integrated with the fixed sleeve 71 so as not to substantially rotate relative to the fixed sleeve 71. Hereinafter, the position of the movable flange 73 relative to the fixed sleeve 71 in the front-rear direction at this time is also referred to as a connected position.

The pressure spring 75 may be a disc spring or a urethane spring in place of a metal compression coil spring. Where a urethane spring is used for the pressure spring 75, for example, a cylindrical urethane rubber may be arranged to surround the shaft part 55, or columnar urethane rubbers may be arranged around the shaft part 55. A urethane spring has a higher spring constant than a metal coil spring. Therefore, the pressure spring 75 can be reduced in length in the front-rear direction by using a urethane spring compared with that using a metal coil spring. Thus, the flare forming device 30 and the flare forming tool 10 can be reduced in length in the front-rear direction.

The movable flange 73 can be moved rearward relative to the fixed sleeve 71 from the connected position to a position (hereinafter referred to as a disconnected position) where the clutch pin 734 is apart from the second sleeve 715. When the movable flange 73 is placed in the disconnected position, the movable flange 73 can rotate together with the main shaft 5 relative to the fixed sleeve 71.

As shown in FIG. 3, part of the rotation stopper 77, a thrust bearing 781 and a washer 785 are disposed between the movable flange 73 and a front end of the pressure spring 75 in the front-rear direction. The front end of the pressure spring 75 abuts on the washer 785. The pressure spring 75 biases the movable flange 73 forward via these (intervening) members.

The rotation stopper 77 rotates integrally with the movable flange 73 around the driving axis DX. The rotation stopper 77 and the movable flange 73 are allowed to rotate in a clockwise direction and restricted from rotating in a counterclockwise direction, relative to the main housing 40 and the fixed sleeve 71, when viewed from the rear. The pressure spring 75 is separated from the rotation of these members by the thrust bearing 781.

### A3. Operation of the Flare Forming Device 30 when the motor 21 is driven

As shown in FIG. 3, in the flare forming device 30, the male thread part 56 of the main shaft 5 is arranged in a position (hereinafter referred to as an initial position) where it can be threadedly engaged with the female thread 737 of the movable flange 73. At this time, the movable flange 73 is located in the connected position and cannot substantially move relative to the fixed sleeve 71 and the main housing40. The controller 20 starts rotation of the motor 21 in the normal direction when the switch 153 is turned on. When the motor 21 is rotated in the normal direction, the main shaft 5 is rotated around the driving axis DX in the clockwise direction as viewed from the rear. The main shaft 5 is moved forward by the feed screw mechanism 6. Rotation in the clockwise direction and rotation in the counterclockwise direction as viewed from the rear are hereinafter also referred to as normal rotation and reverse rotation, respectively.

As shown in FIG. 3, where a pipe P is clamped by the clamping device 80 mounted to the clamp mounting part 60, when the main shaft 5 continues to rotate in the normal direction, the cone 57 abuts on an end of the pipe 9 before the main shaft 5 reaches a frontmost position. As the main shaft 5 rotates while moving forward, the cone 57 expands the end of the pipe P into a cone shape by turning around the driving axis DX while rotating around the axis AX. When the cone 57 expands the end of the pipe P into a cone shape and moves forward to a certain extent while forming a flare, the pipe P held by the clamping device 80 obstructs the forward movement of the cone 57 and thus the main shaft 5 before the main shaft 5 reaches the frontmost position. The position of the main shaft 5 at this time is hereinafter also referred to as a forward movement inhibiting (obstructing) position.

When the main shaft 5 continues to rotate in the normal direction in the forward movement inhibiting position, the movable flange 73 moves rearward relative to the fixed sleeve 71 against the biasing force of the pressure spring 75 by the action of the feed screw mechanism 6. Thus, the clutch pin 734 is moved apart from the second sleeve 715 to the disconnected position where the movable flange 73 can rotate relative to the fixed sleeve 71. The movement of the movable flange 73 from the connected position to the disconnected position is hereinafter also referred to as the operation of the clutch mechanism 7. The shape of the flare is already formed when the main shaft 5 can no longer move forward. Therefore, it can also be said that the clutch mechanism 7 operates according to formation of the flare.

As the movable flange 73 moves rearward, the pressure spring 75 is compressed and the biasing force of the pressure spring 75 increases. When the movable flange 73 reaches the disconnected position, the movable flange 73 does not move any further and starts rotating in the normal direction integrally with the main shaft 5 located in the forward movement inhibiting position.

The biasing force of the pressure spring 75 is applied to the main shaft 5 via the movable flange 73. With the biasing force, the cone 57 supported by the front end part 52 of the main shaft 5 presses the flare substantially in the same position in the front-rear direction while rotating around the axis AX and turning around the driving axis DX. This operation of the cone 57 is hereinafter also referred to as finishing operation.

In this embodiment, when the user releases (depressing of) the trigger 151 and the switch 153 is turned off, the controller 20 stops the motor 21 and then rotates the motor 21 in the reverse direction. When the motor 21 is rotated in the reverse direction while the movable flange 73 is located in the disconnected position, the main shaft 5 is rotated in the reverse direction. Along with this, the main shaft 5 is moved rearward by the feed screw mechanism 6. The movable flange 73 is moved forward by the biasing force of the pressure spring 75 and returns to the connected position.

When the reverse rotation of the main shaft 5 is continued, the main shaft 5 moves rearward while rotating in the reverse direction until the male thread part 56 is disengaged from the female thread 737, and returns to the initial position shown in FIG. 2. The controller 20 stops rotation of the motor 21 in the reverse direction 5 when the main shaft 5 is returned to the initial position.

### A4. Structure of the Clamping Device

As shown in FIG. 3, the clamping device 80 is configured to clamp (hold) the pipe P in a clamp hole 82. The clamping device 80 clamping the pipe P can be fixed to the clamp mounting part 60 provided in the front end part of the flare forming device 30. The flare forming device 30 is configured to form a flare on the pipe P clamped by the clamping device 80.

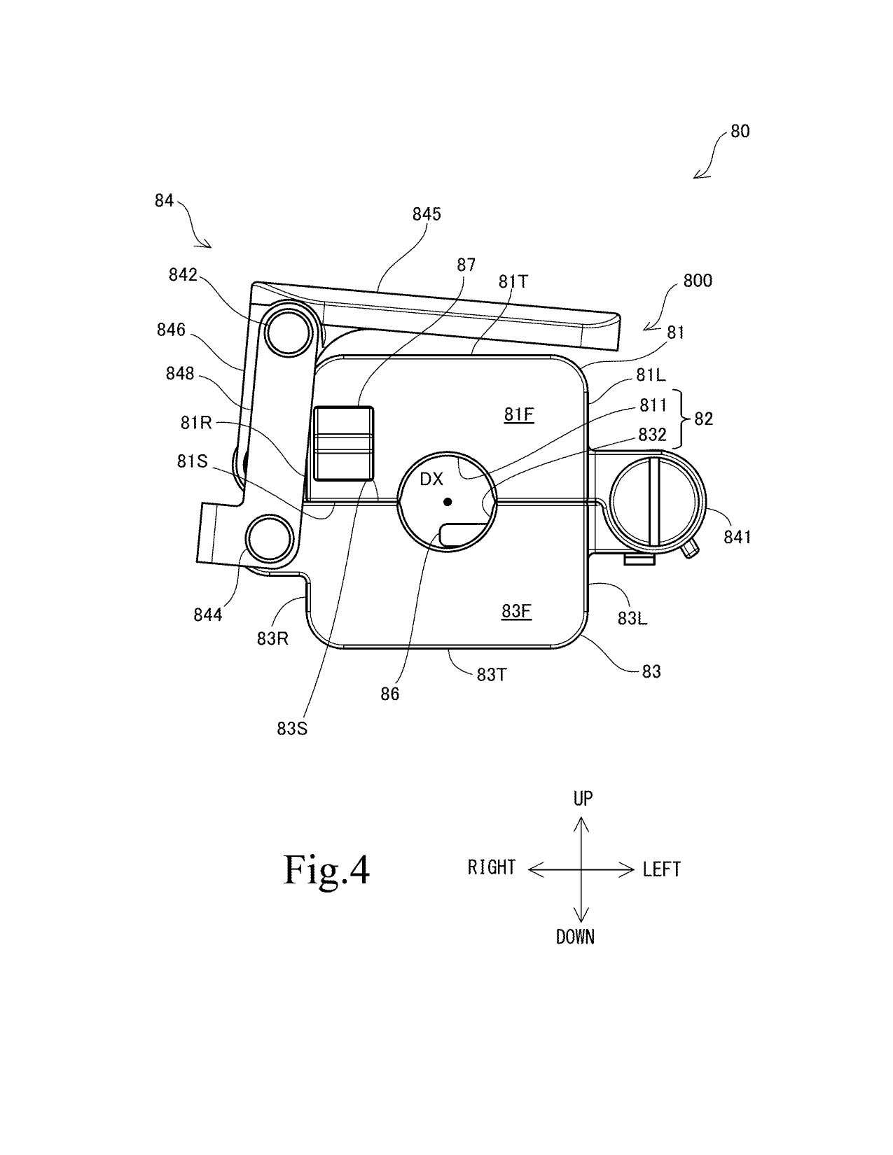

As shown in FIG. 4, the clamping device 80 has a body 800 including first and second bodies 81, 83, a first connection part 841 and an operating mechanism 84. The body 800 is formed of a material having higher hardness than the pipe P, such as iron and aluminum.

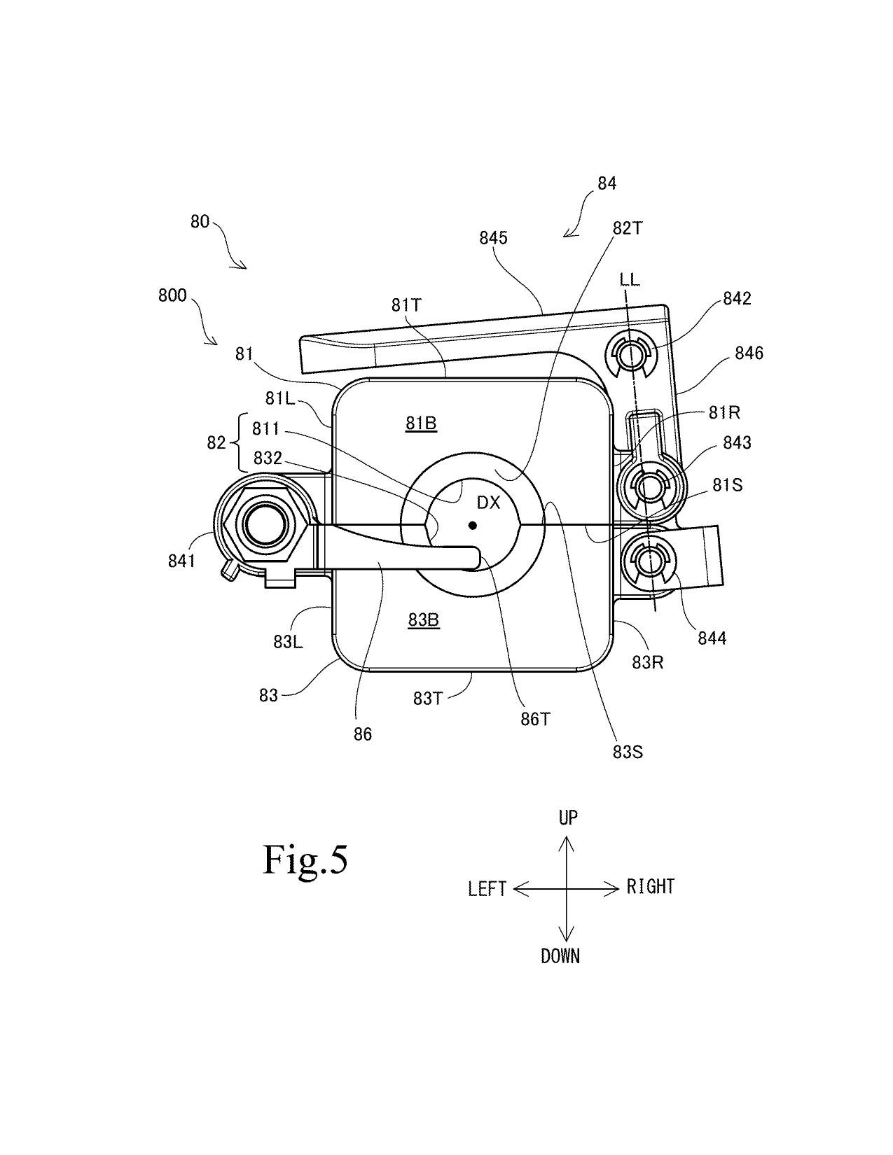

The first body 81 has a generally rectangular parallelepiped shape. The first body 81 has a front part 81F, which forms the front side of the first body 81 when the clamping device 80 is mounted to the flare forming device 30, a back part 81B (see FIG. 5) on the opposite side from the front part 81F, and four side parts that connect the front part 81F and the back part 81B. The back part 81B faces the cone 57 when the clamping device 80 is mounted to the flare forming device 30. The four side parts include a first facing part 81S that faces the second body 83, a first side part 81T on the opposite side from the first facing part 81S, and two side parts that connect the first facing part 81S and the first side part 81T, or a left side part 81L on which the first connection part 841 is provided and a right side part 81R on the opposite side from the left side part 81L. A generally semicircular first recess 811 is formed in the first facing part 81S.

The second body 83 has a generally rectangular parallelepiped shape mirror symmetric to the first body 81. Specifically, the second body 83 has a front part 83F that forms the front side of the first body 83 when the clamping device 80 is mounted to the flare forming device 30, a back part 83B (see FIG. 5) on the opposite side from the front part 83F, and four side parts that connect the front part 83F and the back part 83B. The back part 83B faces the cone 57 when the clamping device 80 is mounted to the flare forming device 30. The four side parts include a second facing part 83S that faces the first body 81, a second side part 83T on the opposite side from the second facing part 83S, and two side parts that connect the second facing part 83S and the second side part 83T, or a left side part 83L on which the first connection part 841 is provided and a right side part 83R on the opposite side from the left side part 83L. A generally semicircular second recess 832 is formed in the second facing part 83S.

The first connection part 841 is provided on a left end of the body 800 and connects the left side part 81L of the first body 81 and the left side part 83L of the second body 83. The first connection part 841 connects the first body 81 and the second body 83 so as to rotate relative to each other. Thus, by rotation of the first and second bodies 81, 83, the body 800 can be switched between a state in which the first body 81 and the second body 83 are close to (or in contact with) each other and a state in which the first body 81 and the second body 83 are apart from each other.

FIGS. 4 and 5 show the first and second bodies 81, 83 which are close to each other. In this state, the first facing part 81S and the second facing part 83S face each other. This positional relation between the first body 81 and the second body 83 is hereinafter also referred to as a “closed position”. The first recess 811 and the second recess 832 form one clamp hole 82 in the body 800 in the closed position. The “state in which the first body 81 and the second body 83 are close to each other” means the state in which the body 800 can hold the pipe P, irrespective of whether the first facing part 81S of the first body 81 and the second facing part 83S of the second body 83 abut on each other, and means the state in which the clamp hole 82 is substantially formed in the body 800.

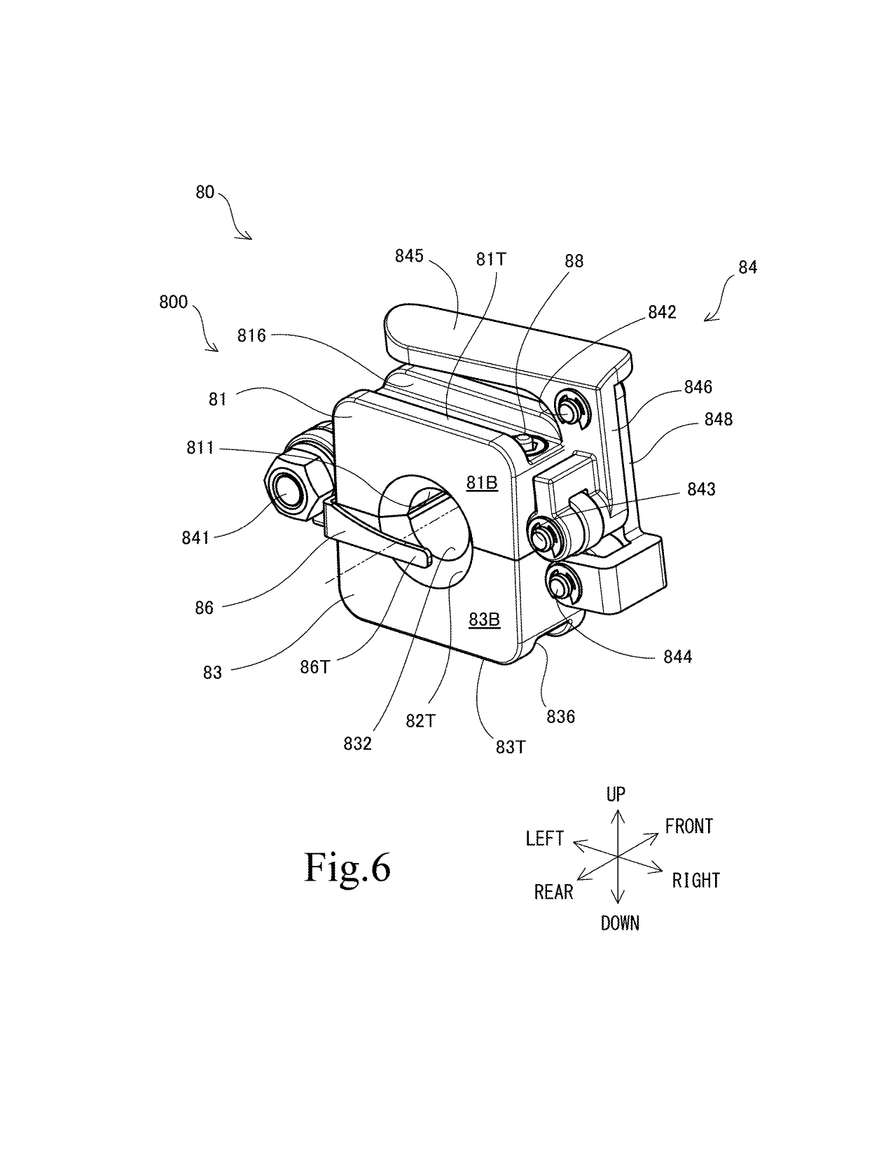

The clamp hole 82 is formed to penetrate from a rear surface to a front surface of the body 800 along the driving axis DX. In this embodiment, as shown in FIGS. 5 and 6, a tapered part 82T is formed around the clamp hole 82 in a rear end part of the body 800 and has a diameter increasing toward a rear end thereof. The tapered part 82T has a shape corresponding to the shape of the flare. The clamp hole 82 having a diameter corresponding to a prescribed pipe diameter is formed in the body 800 of the clamping device 80. Therefore, when machining a pipe having a different pipe diameter, the clamping device 80 that has a clamp hole 82 having a diameter corresponding to the different pipe diameter is used.

The clamp hole 82 is formed slightly smaller than the outer diameter of the pipe P, and the clamping device 80 holds the pipe P in the clamp hole 82 by utilizing reaction force from the pipe P. Therefore, when the pipe P is held by the first and second bodies 81, 83, the first facing part 81S and the first side part 81T may be slightly separated from each other. This state is included in the “state in which the first body 81 and the second body 83 are close to each other”.

When the first body 81 is rotated relative to the second body 83 around the first connection part 841, the first facing part 81S and the second facing part 83S are switched from the closed position to a position in which the first facing part 81S and the second facing part 83S are separated from each other. This position is also referred to as an “open position”. In the open position, the pipe P is not held by the first recess 811 and the second recess 832. The pipe P is set (mounted) to and removed from the clamping device 80 with the first and second bodies 81, 83 in the open position.

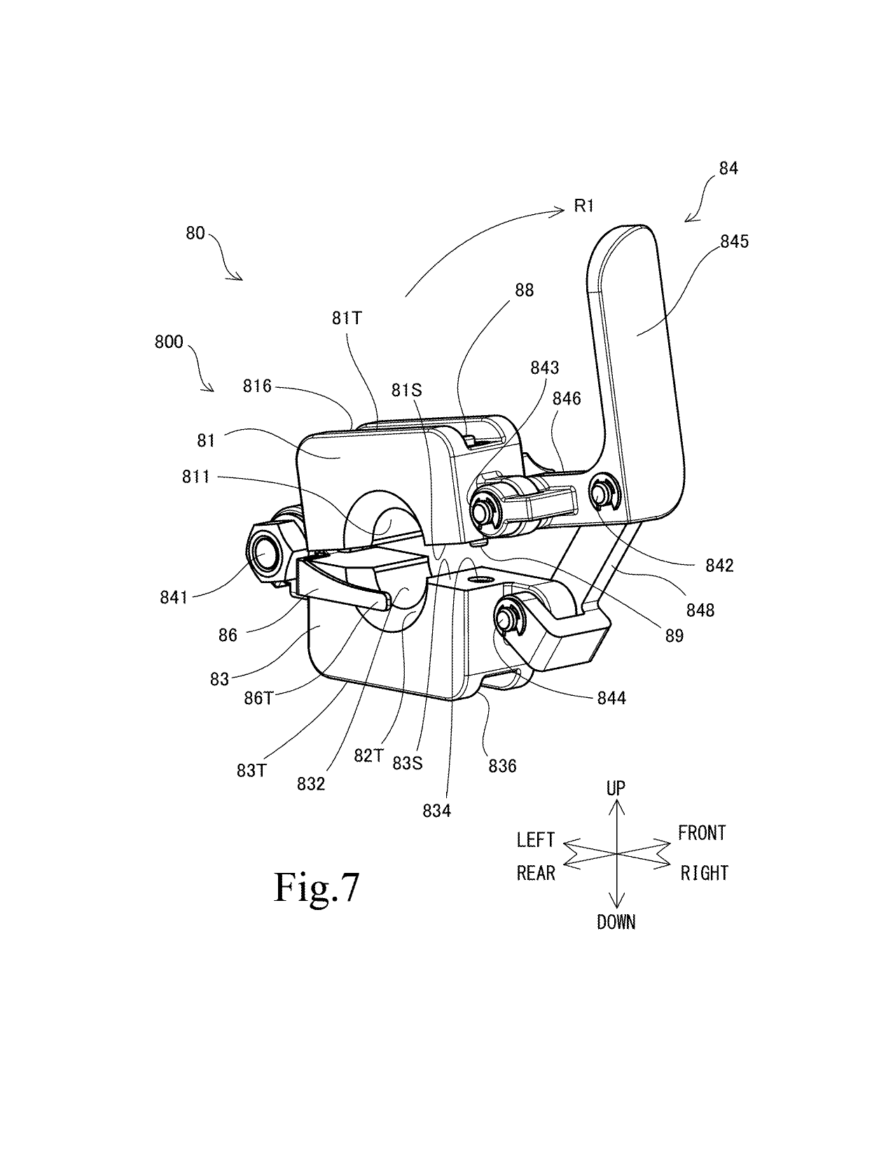

As shown in FIG. 7, in this embodiment, the first facing part 81S of the first body 81 has a fixing pin 89 that protrudes outward from the first facing part 81S, while the second facing part 83S of the second body 83 has an engagement hole 834. The engagement hole 834 is configured to house (receive) the fixing pin 89 when the first and second bodies 81, 83 are in the closed position. The first recess 811 of the first body 81 and the second recess 832 of the second body 83 are aligned to each other in a simple manner of engaging the fixing pin 89 into the engagement hole 834. Further, (positional) displacement between the first body 81 and the second body 83 during flaring operation is suppressed or prevented, and the machining accuracy of the pipe P is improved. The fixing pin 89 may be provided on the second body 83 instead of on the first body 81.

As shown in FIG. 5, a stopper 86 is provided on the rear side of the clamping device 80. The stopper 86 is, for example, connected to the first connection part 841 so as to rotate relative to the second body 83 around the first connection part 841. A tip 86T of the stopper 86 is normally arranged to close part of the clamp hole 82. Thus, a tip of the pipe P can come into contact with the stopper 86 when the pipe P is set between the first recess 811 of the first body 81 and the second recess 832 of the second body 83. In this manner, the pipe P is positioned relative to the clamping device 80 in the front-rear direction by the stopper 86. Further, when the pipe P is held in the clamp hole 82, the tip of the pipe P is restrained or prevented from protruding from the clamp hole 82.

The tip 86T of the stopper 86 is arranged in a position overlapping the clamp hole 82 and apart from the driving axis DX, when the clamping device 80 is viewed from the front along the driving axis DX. With this arrangement, during flare forming operation, the cone 57 is moved toward the tip 86T from behind the body 800, and the cone part 571 of the cone 57 pushes out the tip 86T in a direction away from the driving axis DX. Thus, the stopper 86 is configured not to obstruct the movement of the cone 57 in the front-rear direction.

The operating mechanism 84 is a mechanism for opening and closing the first and second bodies 81, 83 of the body 800. The operating mechanism 84 is configured to switch the arrangement of the first and second bodies 81, 83 between the closed position and the open position by utilizing a booster mechanism. The booster mechanism means a mechanism for opening and closing the body 800 by utilizing a moment balance. The clamping device 80 is configured such that the booster mechanism is used to increase the force for holding the pipe P by the first and second bodies 81, 83 while reducing (or minimizing) a force required to operate the operating mechanism 84. In this embodiment, the booster mechanism is formed by a toggle mechanism including the first connection part 841, a first link 846, a second link 848 and a second connection part 842.

As shown in FIGS. 5 and 6, the first link 846 is rotatably connected to the second link 848 via the second connection part 842. The first link 846 is also rotatably connected to the first body 81 via a third connection part 843. The third connection part 843 is provided on the right side part 81R of the first body 81 on the opposite side of the clamp hole 82 from the first connection part 841. The first link 846 has a generally rectangular column shape extending on a line connecting the second connection part 842 and the third connection part 843. The first link 846 is connected to a lever 845.

As shown in FIGS. 4 and 6, the second link 848 is rotatably connected to the second body 83 via a fourth connection part 844. The second link 848 is also rotatably connected to the first link 846 via the second connection part 842. The fourth connection part 844 is provided on the right side part 83R of the second body 83 on the opposite side of the clamp hole 82 from the first connection part 841. The second link 848 has a generally rectangular column shape extending on a line connecting the second connection part 842 and the fourth connection part 844.

As shown in FIG. 5, the lever 845 is used for an operation of opening and closing the body 800 by the operating mechanism 84. In this embodiment, the first link 846 and the lever 845 are integrally formed as a single part. The lever 845 extends in a direction substantially orthogonal to the extending direction of the first link 846, and is formed to be bent toward the first side part 81T of the first body 81. With this configuration, the lever 84 and the first link 846 are arranged along an outer contour of the first body 81. Thus, the clamping device 80 is reduced in size when the first and second bodies 81, 83 are in the closed position. In this embodiment, the first link 846 and the lever 845 may be formed by connecting different parts formed separately from each other.

As shown in FIG. 5, in this embodiment, the clamping device 80 is formed by a four-joint link in which the first connection part 841 and the fourth connection part 844 are fixed. The third connection part 843 is configured to be operated by input from the second connection part 842 via the lever 845. When the first and second bodies 81, 83 are in the closed position, the third connection part 843 is located outward of a line LL connecting the second connection part 842 and the fourth connection part 844, and the clamping device 80 is locked.

As shown in FIG. 7, when the lever 845 is turned in a direction R1 away from the first body 81 around the third connection part 843, the clamping device 80 is unlocked, and the first and second bodies 81, 83 are switched to the open position. The clamping device 80 is configured such that, by utilizing the booster mechanism, the lever 845 can be operated with a relatively small force while the pipe P can be held in the clamp hole 82 with a force larger than the force for operating the lever 845. Thus, the pipe P can be firmly held by a simple operation of operating the lever 845, so that the pipe P can be restrained or prevented from being displaced after the pipe P is held in the clamp hole 82 of the clamping device 80.

### A5. Engagement Mechanism between the clamping device 80 and the clamp mounting part 60

As shown in FIG. 3, the clamping device 80 is configured to be engaged with the clamp mounting part 60 by being slid in a direction (the left-right direction in the example shown in FIG. 3) orthogonal to the driving axis DX relative to the clamp mounting part 60. An engagement mechanism between the clamping device 80 and the clamp mounting part 60 includes a pair of guide rails 66 formed on the clamp mounting part 60, and first and second grooves 816, 836 formed in the clamping device 80.

As shown in FIG. 3, the guide rails 66 are arranged to face each other across the driving axis DX. The guide rails 66 are projections protruding inward in a radial direction around the driving axis DX. The guide rails 66 extend in a direction (the left-right direction in the example shown in FIG. 3) orthogonal to the driving axis DX.

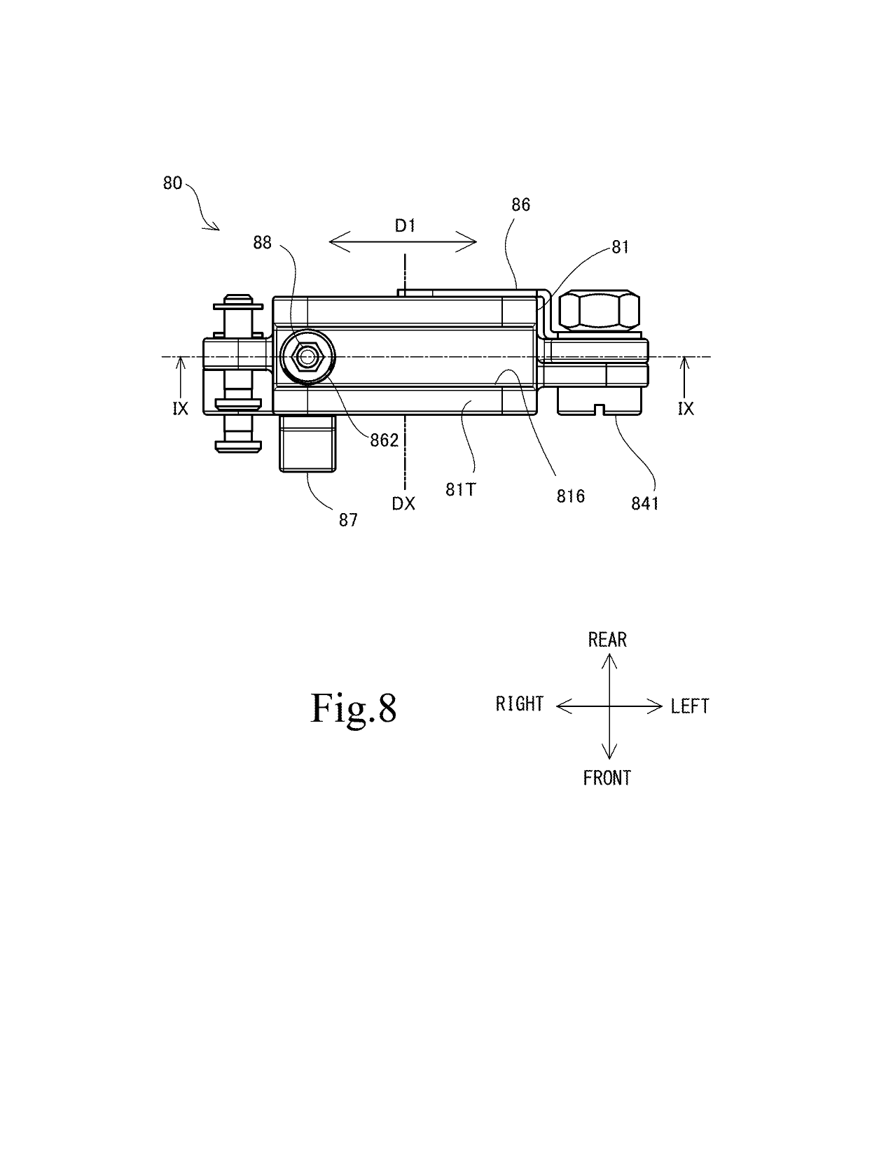

As shown in FIG. 8, the first groove 816 is a recess extending linearly in the first side part 81T of the first body 81. An extending direction D1 of the first groove 816 is a direction crossing (specifically, substantially orthogonal to) the driving axis DX. In FIG. 8, for ease of technical understanding, the lever 845 is not shown

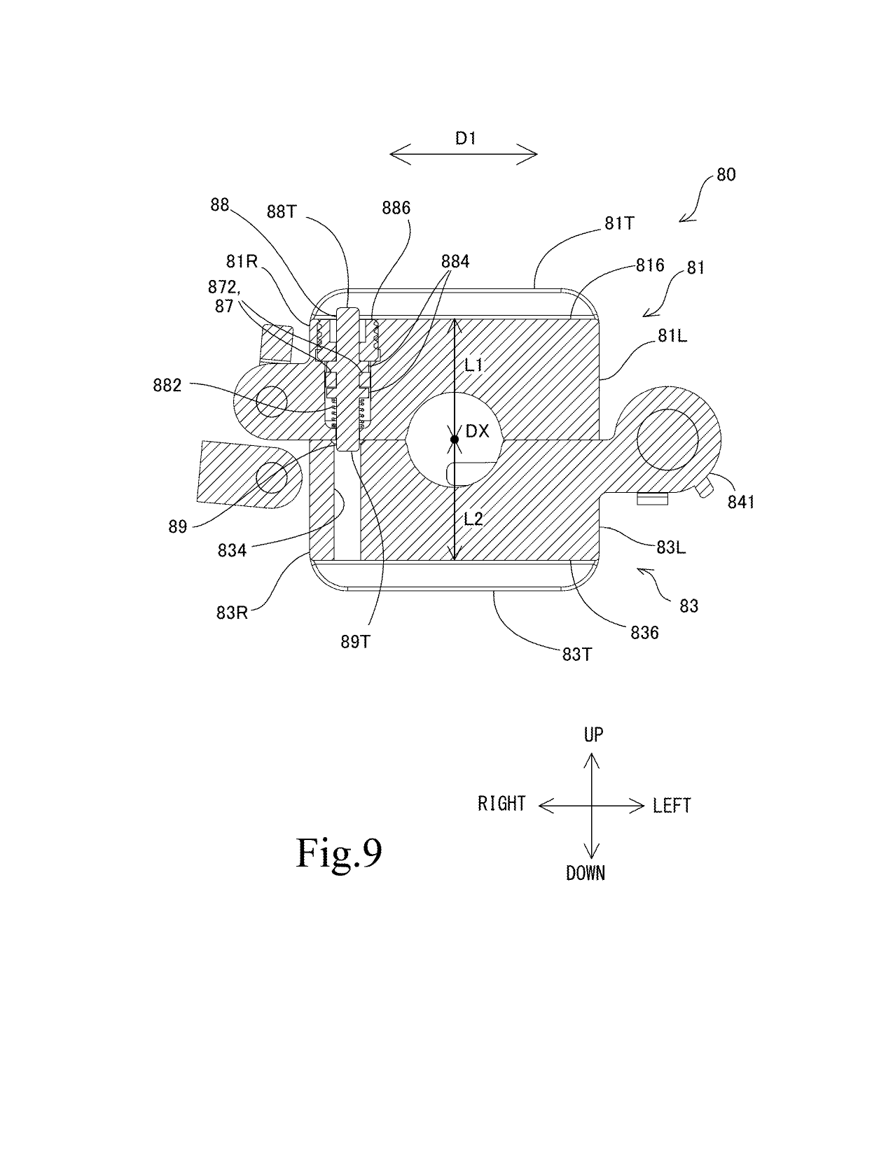

As shown in FIG. 9, the second groove 836 is a recess extending linearly in the second side part 83T of the second body 83. The second groove 836 is formed similarly to the first groove 816. An extending direction of the second groove 836 is a direction crossing (specifically, substantially orthogonal to) the driving axis DX and substantially parallel to the extending direction D1 of the first groove 816.

The first and second grooves 816, 836 are arranged to face each other across the clamp hole 82. Specifically, the first and second grooves 816, 836 are arranged to face in parallel to each other. The extending direction D1 of the first and second grooves 816, 836 defines a mounting (inserting) direction of mounting (inserting) the clamping device 80 to the clamp mounting part 60. In the following description, for ease of description, the extending direction D1 is also referred to as the mounting (inserting) direction D1.

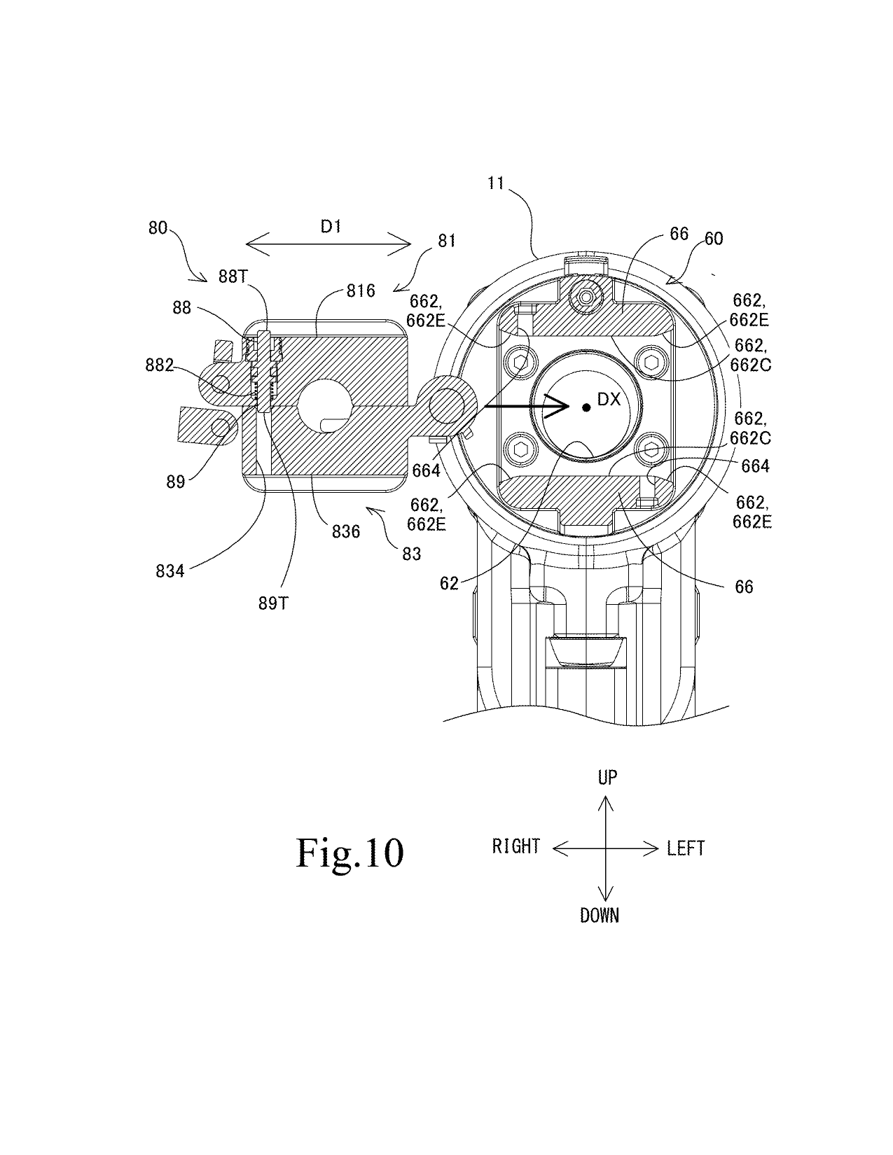

As shown in FIG. 10, the clamping device 80 is engaged with the clamp mounting part 60 by sliding the first and second grooves 816, 836 toward the guide rails 66 of the clamp mounting part 60 along the extending direction D1 of the first and second grooves 816, 836. Thus, the clamping device 80 can be mounted to the clamp mounting part 60 in a simple manner of sliding the clamping device 80.

The guide rails 66 of the clamp mounting part 60 are engaged with the first and second grooves 816, 836 formed in the side parts (specifically, the first side part 81T of the first body 81 and the second side part 83T of the second body 83). Thus, the clamping device 80 can be mounted to the clamp mounting part 60 without need of extending the clamp mounting part 60 on a front part of the clamping device 80. Therefore, the clamp mounting part 60 can be reduced in length in the front-rear direction, so that a length LA (shown in FIG. 2) of the flare forming tool 10 in the front-rear direction and a length of the flare forming device 30 in the front-rear direction can be reduced.

As shown in FIG. 9, the first groove 816 is formed in the first side part 81T to extend from the right side part 81R to the left side part 81L of the first body 81. Similarly to the first groove 816, the second groove 836 is formed in the second side part 83T to extend from the right side part 83R to the left side part 83L of the second body 83. In other words, both ends of each of the first and second grooves 816, 836 are open. With this configuration, the clamping device 80 can be engaged with the guide rails 66 from either side in the extending direction D1.

As shown in FIG. 10, the guide rails 66 are arranged to face each other across the driving axis DX. The guide rails 66 have substantially the same structure, so that the first groove 816 as well as the second groove 836 can be engaged with both of the guide rails 66. Thus, the clamping device 80 can be engaged with the clamp mounting part 60 even if the positional relation between the first body 81 and the second body 83 is reversed.

As shown in FIG. 6, components (elements) of the clamping device 80 are not arranged around the first and second grooves 816, 836 of the clamping device 80. Specifically, the first to fourth connection parts 841, 842, 843, 844 and the lever 845 are not arranged above the first grove 816 or on the left and right sides of the first grove 816, or below the second groove 836 or on the left and right sides of the second groove 836.

More specifically, the first connection part 841, the third connection part 843 and the fourth connection part 844 are arranged away from the left and right ends of the first and second grooves 816, 836 between the first groove 816 and the second groove 836 in the up-down direction. The second connection part 842 and the lever 845 are arranged forward of the first and second grooves 816, 836 in the front-rear direction, away from an area just above the first groove 816 and an area just below second groove 836. With this arrangement, the first to fourth connection parts 841, 842, 843, 844 and the lever 845 is prevented from interfering with the guide rails 66 when the first and second grooves 816, 836 are engaged with the guide rails 66.

### A6. Mechanism for fixing the clamping device 80 to the clamp mounting part 60

A mechanism for fixing the clamping device 80 to the clamp mounting part 60 is now described. As shown in FIGS. 8 and 9, a positioning pin 88 is provided in the first groove 816. In this embodiment, as shown in FIG. 10, when the positioning pin 88 is engaged in an engagement hole 664 of the clamp mounting part 60, the clamping device 80 engaged with the clamp mounting part 60 is fixed to a prescribed position of the clamp mounting part 60. In the following description, the position in which the clamping device 80 is mounted and fixed to the clamp mounting part 60 is also referred to as a “fixed position”.

As shown in FIG. 9, the positioning pin 88 is a long shaft-like member. The positioning pin 88 is arranged in the first body 81 such that an axial direction of the positioning pin 88 corresponds to a direction crossing (specifically, a direction substantially orthogonal to) the extending direction D1 of the first groove 816. In the example shown in FIG. 9, the axial direction of the positioning pin 88 is orthogonal to the extending direction D1 and the driving axis DX and parallel to the up-down direction. In this embodiment, the positioning pin 88 inserted into the first body 81 is covered by a cover part 886 while a tip 88T of the positioning pin 88 protrudes from an opening of the cover part 886. The cover part 886 is integrated with the first body 81 by being threadedly engaged with the first body 81. The positioning pin 88 is restricted from moving in the axial direction by contact with the cover part 886.

The positioning pin 88 is arranged in the first body 81 so as to be movable in the axial direction. Specifically, the positioning pin 88 can be moved in the axial direction to be switched between a protruding position in which the tip 88T of the positioning pin 88 protrudes outside from the first body 81 (more specifically, the first groove 816) and a housing position in which the tip 88T is housed in the first body 81. In the protruding position, the positioning pin 88 is engaged in the engagement hole 664 formed in the guide rail 66.

A biasing member 882 is arranged around the positioning pin 88. The biasing member 882 is a compression coil spring, and biases the positioning pin 88 outward from the first body 81 in the axial direction. The positioning pin 88 is restricted from moving in the axial direction by the cover part 886, and normally biased by the biasing member 882 to be placed in the protruding position.

The positioning pin 88 moves to the housing position by receiving the pressing force against the biasing force of the biasing member 882 from the flare forming device 30 (in this embodiment, the guide rails 66 of the clamp mounting part 60) until the clamping device 80 engaged with the clamp mounting part 60 reaches the fixed position. When the clamping device 80 is placed in the fixed position of the flare forming device 30, the biasing member 882 is released from the pressing force received from the flare forming device 30. The positioning pin 88 is biased by the biasing member 882 to be switched from the housing position to the protruding position and engaged with the flare forming device 30 (in this embodiment, the engagement hole 664). The clamping device 80 is fixed in the fixed position by the positioning pin 88 engaged with the flare forming device 30.

In this embodiment, the positioning pin 88 has a pair of flanges 884. The flanges 884 are parts having a larger diameter than the other part of the positioning pin 88. The flanges 884 are arranged to face each other on the axis of the positioning pin 88. A connection part 872 of an operation part 87 (see FIG. 4) is arranged between the flanges 884.

The connection part 872 is connected to the positioning pin 88 between the flanges 884. When the operation part 87 is moved in the up-down direction, the connection part 872 biases the flanges 884 to move the positioning pin 88 in the up-down direction. Thus, the position of the positioning pin 88 can be switched between the protruding position and the housing position by operating the operation part 87. In this embodiment, with the presence of the biasing member 882, the user can move the positioning pin 88 to the housing position by manually moving the operation part 87 against the biasing force of the biasing member 882.

In this embodiment, the fixing pin 89 is formed on the opposite side from the tip 88T of the positioning pin 88. Thus, the fixing pin 89 is integrally formed with the positioning pin 88. With this configuration, the number of parts of the clamping device 80 can be reduced compared with a configuration in which the fixing pin 89 is separately formed from the positioning pin 88.

As shown in FIG. 10, the guide rails 66 are arranged to face each other across the driving axis DX in the clamp mounting part 60. Each of the guide rails 66 has the engagement hole 664 and a pressing part 662. The guide rails 66 have substantially the same structure, and in the following, the structure of the guide rail 66 arranged above the driving axis DX is described.

The engagement hole 664 is configured to receive the positioning pin 88 placed in the protruding position. The position of the engagement hole 664 relative to the driving axis DX defines the fixed position of the clamping device 80 relative to the driving axis DX. Specifically, the engagement hole 664 is arranged such that the center of the clamp hole 82 is located on the driving axis DX when the positioning pin 88 is engaged in the engagement hole 664. With this configuration, the clamp hole 82 can be easily positioned relative to the driving axis DX when the clamping device 80 is mounted to the clamp mounting part 60. The engagement hole 664 is not limited to a through hole, but may be a bottomed recess.

As shown in FIG. 10, the pressing part 662 is configured to press the positioning pin 88 against the biasing force of the biasing member 882. Specifically, the pressing part 662 has an inclined first part 662E and a second part 662C having substantially a uniform thickness in the guide rail 66. The second part 662C has substantially the same thickness as the depth of the first and second grooves 816, 836. On the second part 662C, the positioning pin 88 is restricted from moving (protruding) outside from the first groove 816 by the second part 662C and held in the housing position. The first part 662E is inclined so as to have a thickness smaller than that of the second part 662C and gradually increasing toward the second part 662C.

The second part 662C is formed continuously to the engagement hole 664. Thus, the pressing part 662 is continuously formed to extend to the engagement hole 664. The pressing part 662 presses the positioning pin 88 located in the protruding position with a gradually increasing force and gradually moves the positioning pin 88 from the protruding position toward the housing position, by utilizing the inclination of the first part 662E of the guide rail 66. When the clamping device 80 is further slid along the guide rail 66 and the positioning pin 88 reaches the second part 662C, the positioning pin 88 is placed in the housing position. When the clamping device 80 is further slid along the guide rail 66 and the positioning pin 88 reaches the engagement hole 664, the positioning pin 88 can be moved from the housing position to the protruding position.

In this embodiment, the first part 662E of the pressing part 662 is formed in an end part of the guide rail 66. The presence of the first part 662E in the end part of the guide rail 66 reduces the possibility that the positioning pin 88 in the protruding position might otherwise get caught on the guide rail 66 when the clamping device 80 (specifically, the first and second grooves 816, 836) is engaged with the guide rail 66. Thus, the clamping device 80 can be smoothly engaged with the clamp mounting part 60. Further, the first part 662E is formed in both end parts of the guide rail 66, so that the clamping device 80 can be smoothly engaged with the clamp mounting part 60 from either side of the clamp mounting part 60.

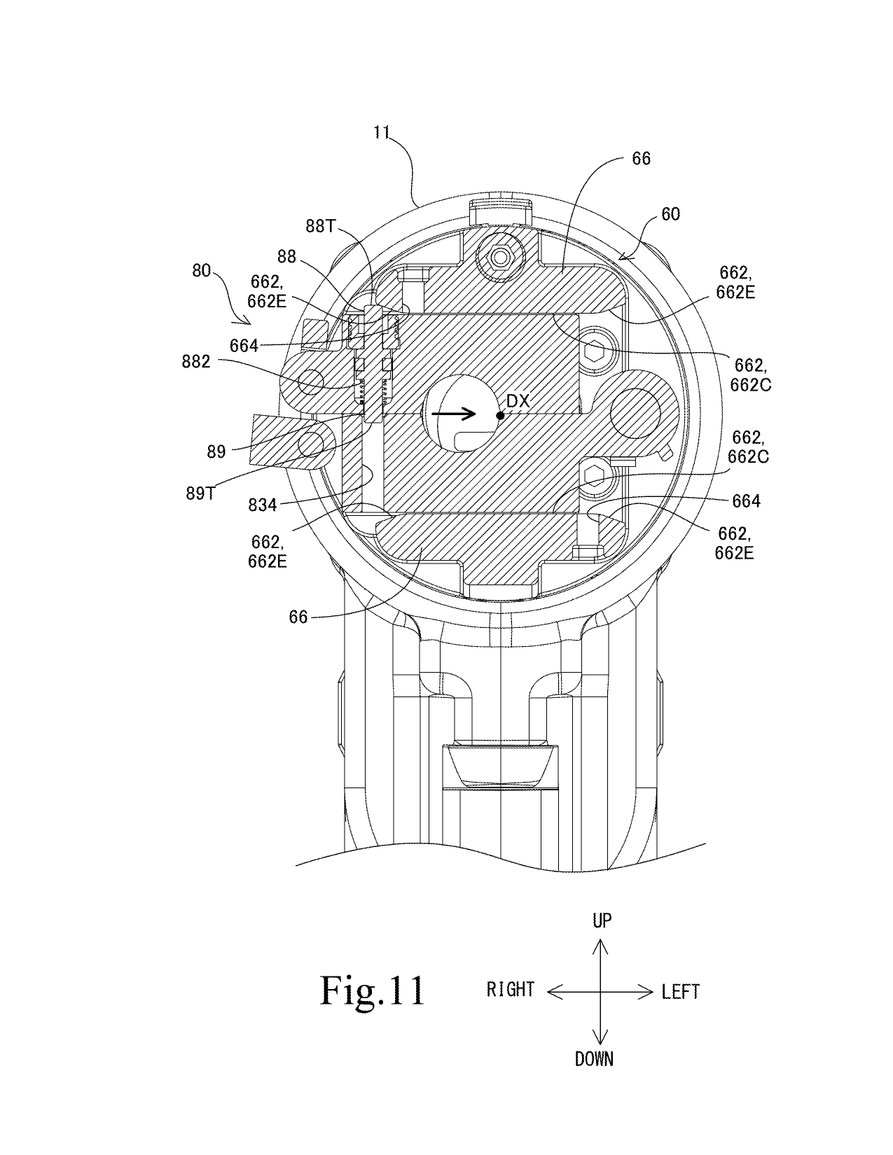

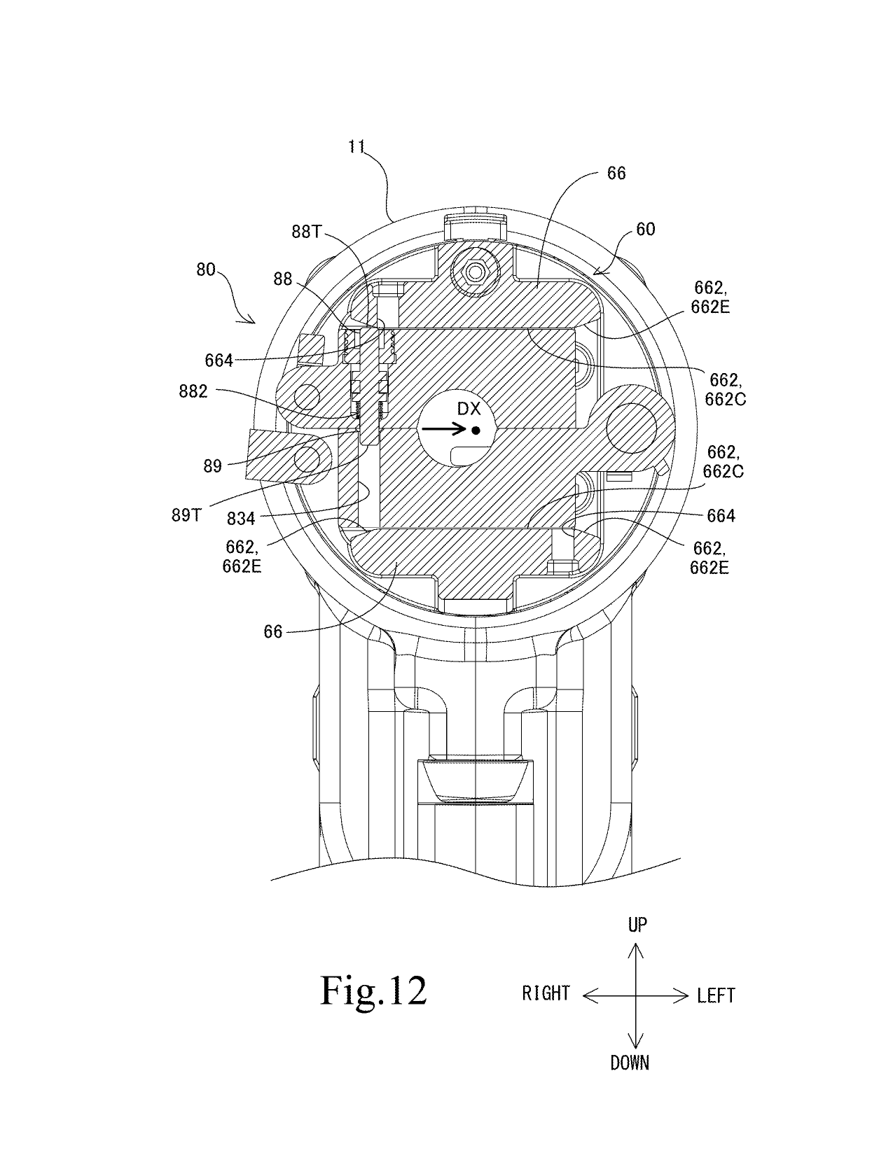

When the clamping device 80 is engaged with the guide rail 66 along the inserting (mounting) direction D1, as shown in FIG. 11, the tip 88T of the positioning pin 88 comes into contact with the first part 662E of the pressing part 662. As shown in FIG. 12, when the clamping device 80 is further slid along the guide rail 66, the pressing part 662 gradually presses (pushes) the positioning pin 88 into the housing position against the biasing force of the biasing member 882.

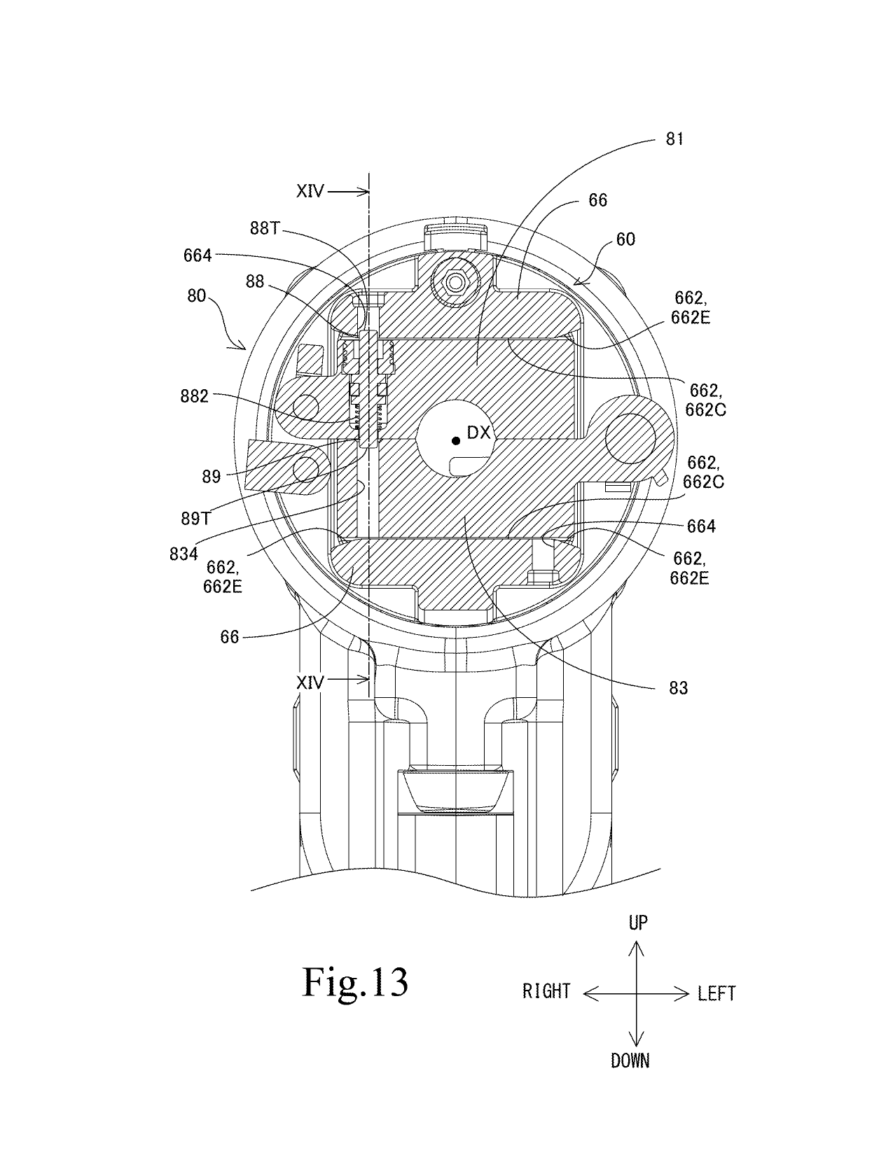

As shown in FIG. 13, when the clamping device 80 reaches the prescribed fixed position, the positioning pin 88 reaches the engagement hole 664. The positioning pin 88 is released from (the pressing of) the pressing part 662 and moved to the protruding position by a restoring force of the biasing member 882. The positioning pin 88 is engaged in the engagement hole 664 so that the clamping device 80 is restricted from moving in the inserting direction D1 relative to the clamp mounting part 60. In this embodiment, the positioning pin 88 can be engaged in the engagement hole 664 without manually switching the positioning pin 88 between the protruding position and the housing position, by utilizing the biasing member 882.

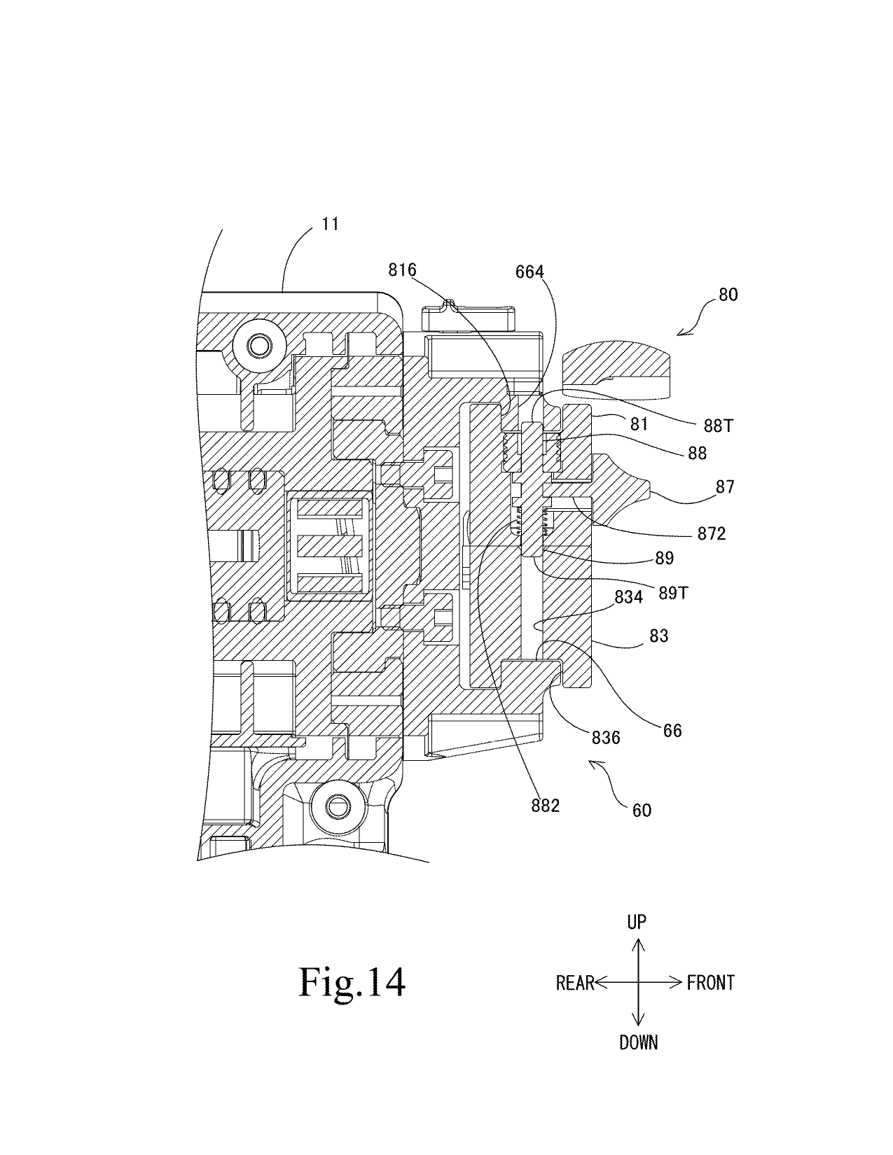

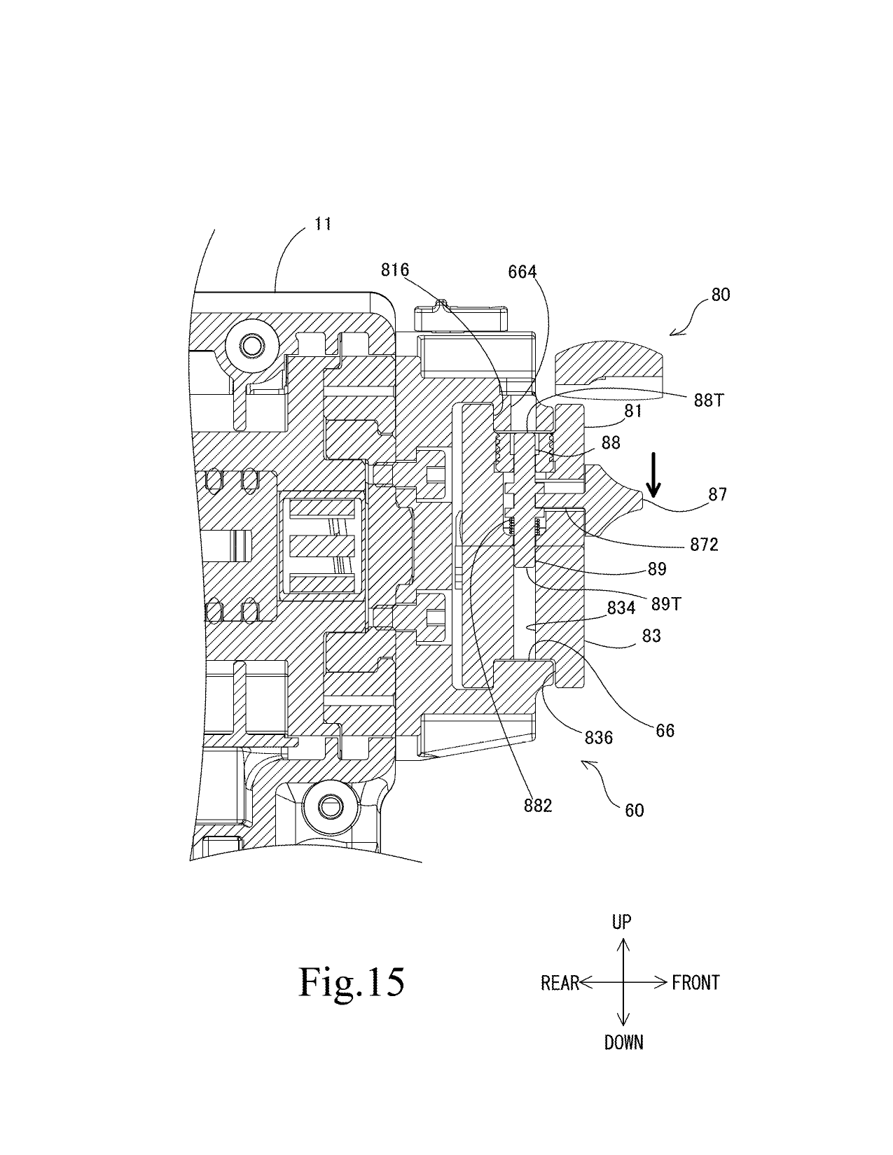

As shown in FIG. 14, the operation part 87 is placed at an upper end in a movable range when the positioning pin 88 is placed in the protruding position and engaged in the engagement hole 664. In order to remove the clamping device 80 from the clamp mounting part 60, the operation part 87 is manually pushed downward. As shown in FIG. 15, when the operation part 87 is pushed downward, the positioning pin 88 is moved from the protruding position to the housing position. Thus, the positioning pin 88 is disengaged from the engagement hole 664. The user can remove the clamping device 80 from the clamp mounting part 60 by sliding the clamping device 80 in the extending direction D1 of the first groove 816 while the operation part 87 is pushed downward.

As shown in FIGS. 14 and 15, the fixing pin 89 is arranged on the opposite side from the positioning pin 88. As described above, the fixing pin 89 protrudes toward the second body 83 from the first facing part 81S of the first body 81 and is engaged in the engagement hole 834 of the second body 83. In this embodiment, a tip 89T of the fixing pin 89 protrudes toward the second body 83 from the first facing part 81S even when the positioning pin 88 is switched to either the protruding position or the housing position by the operation part 87. Thus, the first body 81 and the second body 83 are not disengaged from each other even when the positioning pin 88 is switched between the protruding position and the housing position.

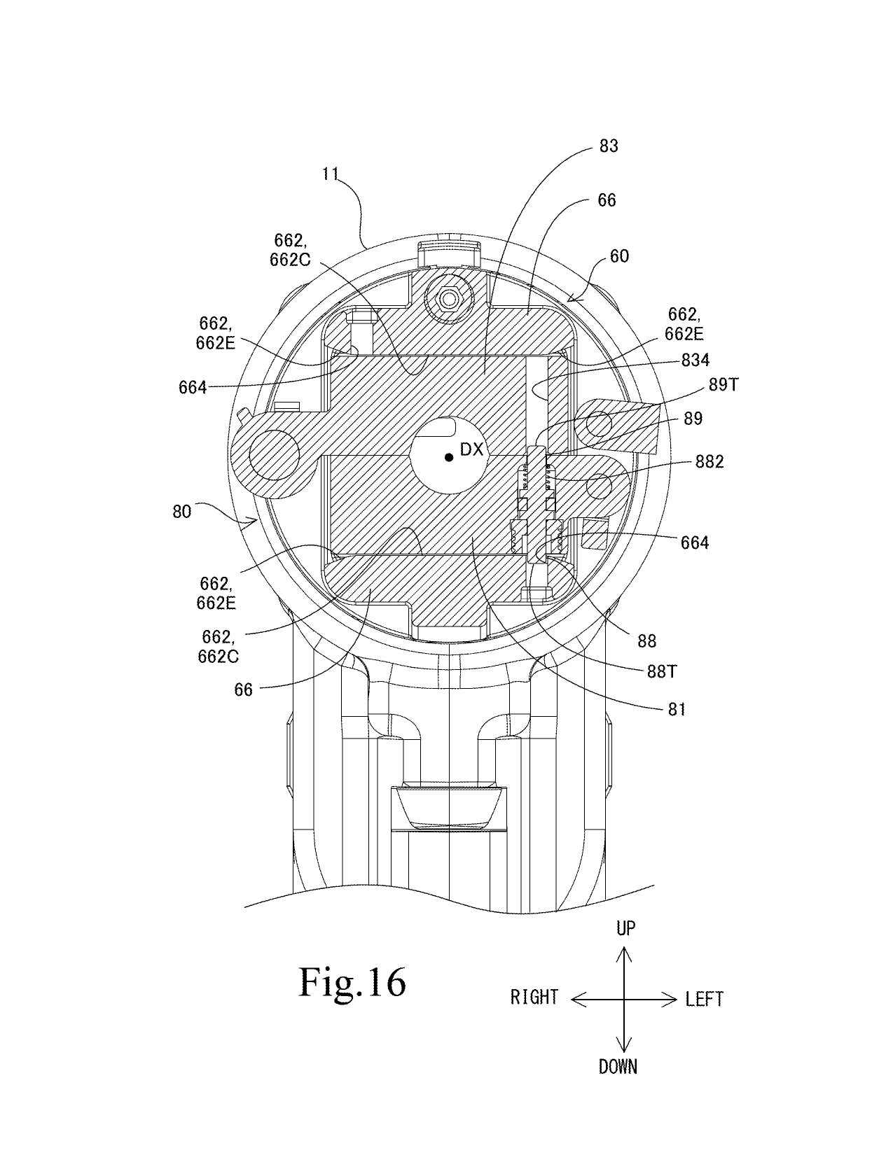

FIG. 16 shows the clamp mounting part 60, with the clamping device 80 mounted thereto, where the positional relation between the first body 81 and the second body 83 is reversed, but the orientation of the flare forming tool 10 is not changed. The clamping device 80 shown in FIG. 16 is reversed upside down from a state shown in FIG. 13. Specifically, the first body 81 is arranged on the lower side and the second body 83 is arranged on the upper side, relative to the driving axis DX.

As shown in FIG. 9, the first groove 816 and the second groove 836 are arranged in point symmetry with respect to the driving axis DX when the clamping device 80 is viewed from the front along the driving axis DX. Specifically, when the clamping device 80 is viewed from the front, the first and second grooves 816, 836 are arranged to face in parallel to each other as described above. Further, the first and second grooves 816, 836 are arranged such that a shortest distance L1 from the driving axis DX to the first groove 816 is equal to a shortest distance L2 from the driving axis DX to the second groove 836.

As shown in FIG. 10, the guide rails 66 of the clamp mounting part 60 are arranged in point symmetry with respect to the driving axis DX when the clamping device 80 is viewed from the front along the driving axis DX. Specifically, when the clamp mounting part 60 is viewed from the front, the guide rails 66 are arranged to face in parallel to each other. The guide rails 66 are arranged such that a shortest distance from the driving axis DX to one of the guide rails 66 is equal to a shortest distance from the driving axis DX to the other guide rail 66. The pressing part 662 and the engagement hole 664 are formed in each of the guide rails 66 and arranged in point symmetry (to those of the other guide rail 66) with respect to the driving axis DX.

In the clamping device 80 of this embodiment, as described above, the first and second grooves 816, 836 and the guide rails 66 are arranged in point symmetry with respect to the driving axis DX. Therefore, as shown in FIG. 16, the clamping device 80 can be engaged with the guide rails 66 of the clamp mounting part 60 even if the arrangement positions of the first body 81 and the second body 83 (the first groove 816 and the second groove 836) are reversed relative to the driving axis DX. Further, the both ends of the first and second grooves 816, 836 and the both ends of the guide rails 66 are open, so that the clamping device 80 can be engaged with the guide rails 66 from either side in the extending direction D1. Thus, the flare forming tool 10 and the flare forming device 30 are provided to which the clamping device 80 can be easily mounted.

### A7. Mechanism for rotating the clamp mounting part 60

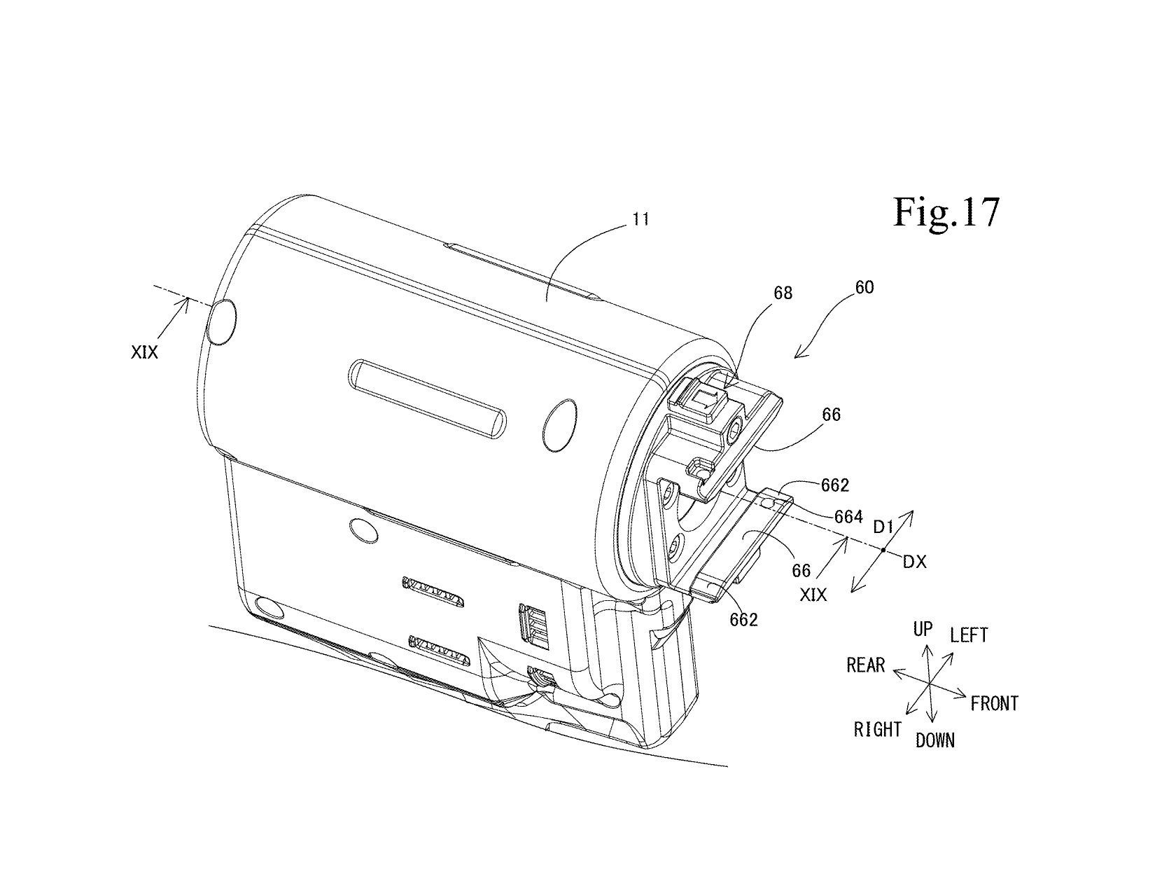

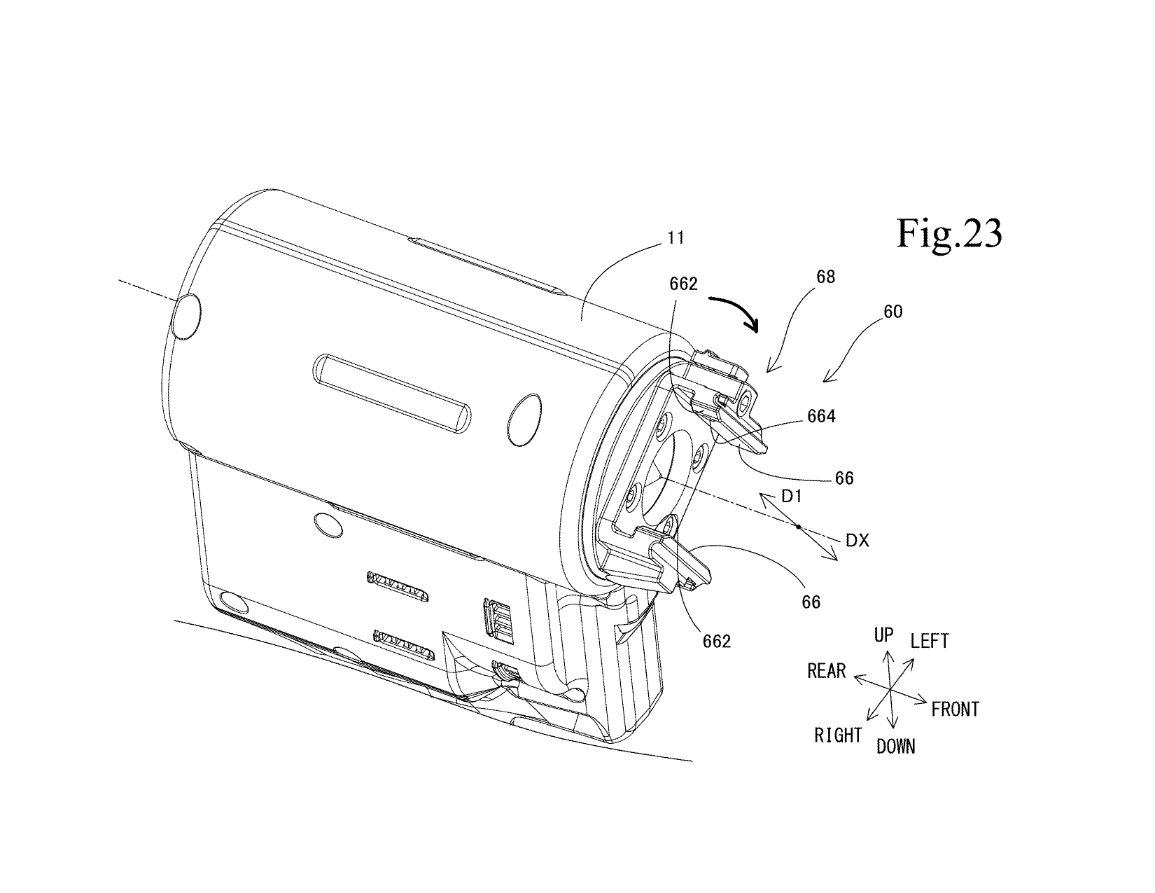

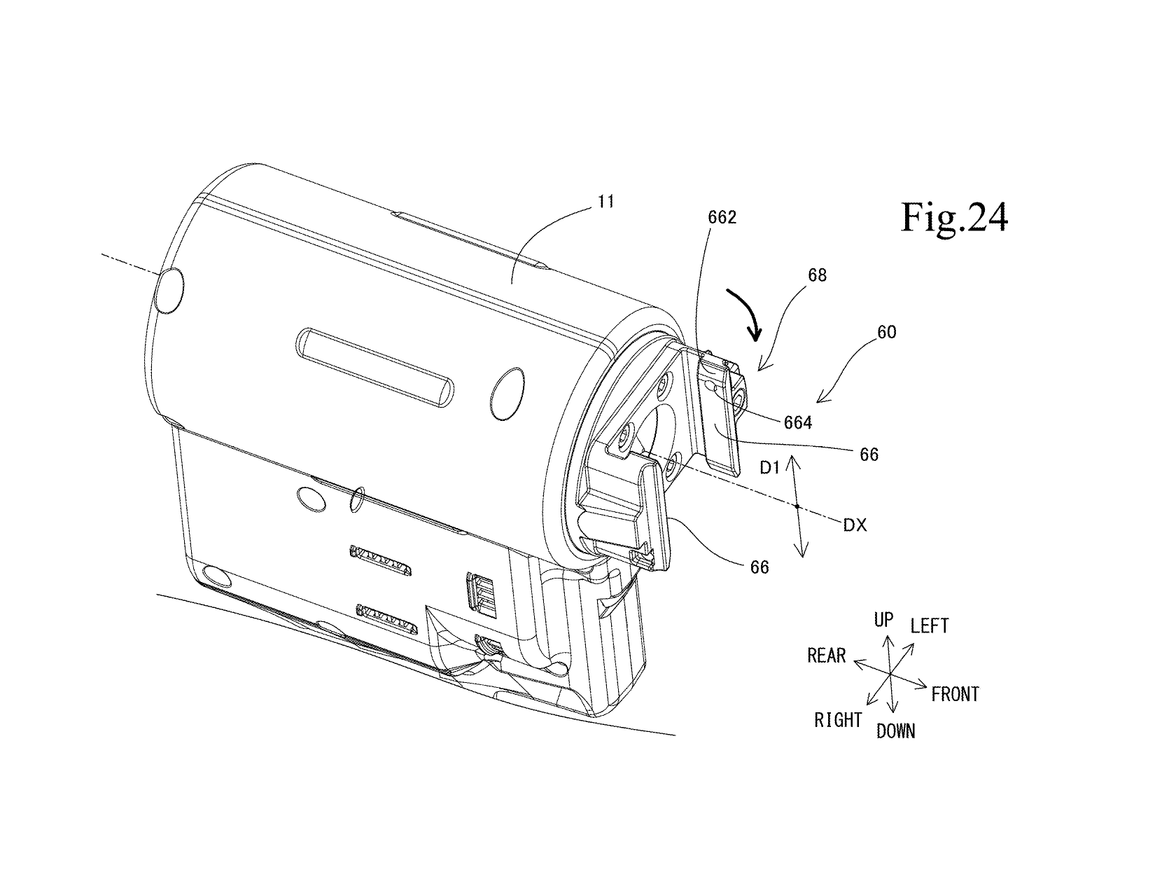

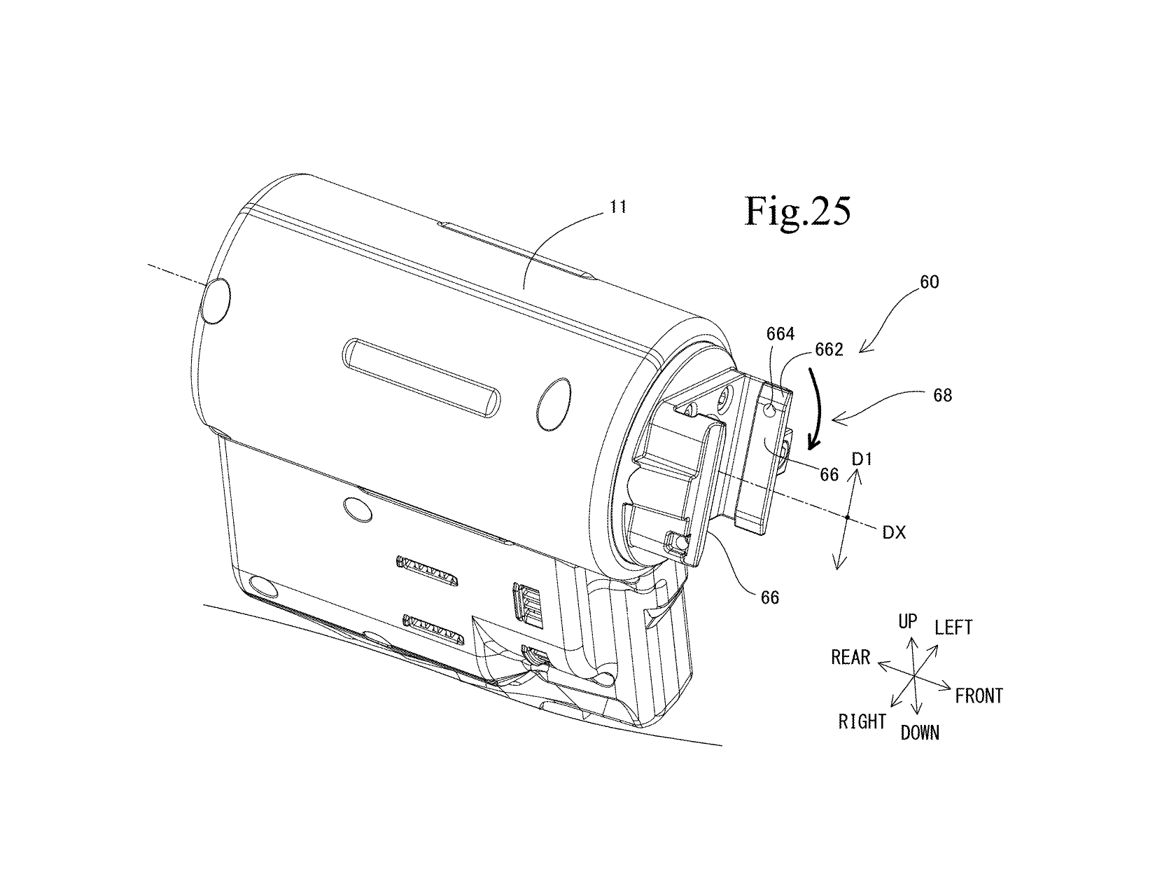

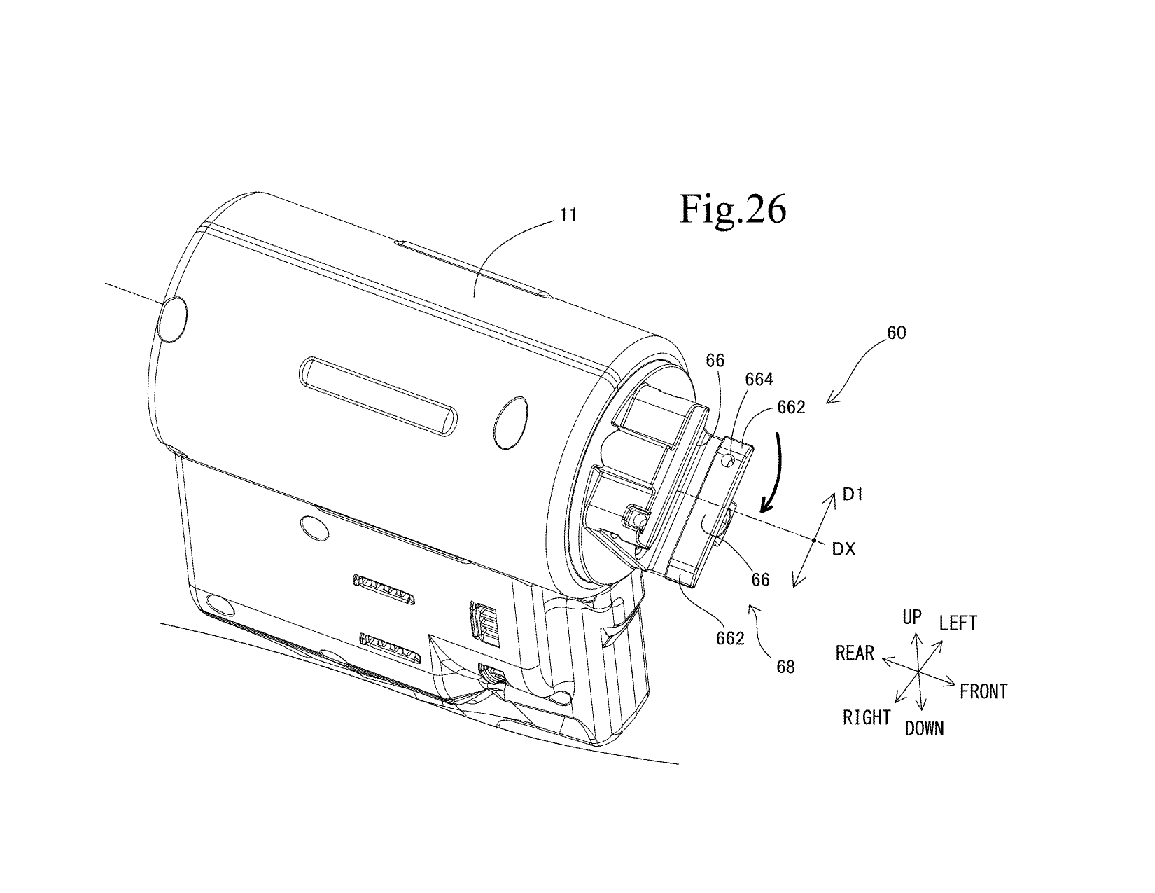

A mechanism for rotating the clamp mounting part 60 is described with reference to FIGS. 17 to 26. In the flare forming device 30 of this embodiment, the clamp mounting part 60 is configured to be rotated around the driving axis DX relative to the main housing 40 of the flare forming device 30. In FIG. 17, the inserting direction D1 of the clamping device 80 is substantially parallel to the left-right direction. In the following, the rotation angle of the clamping device 80 in this state is also referred to as a first rotation angle.

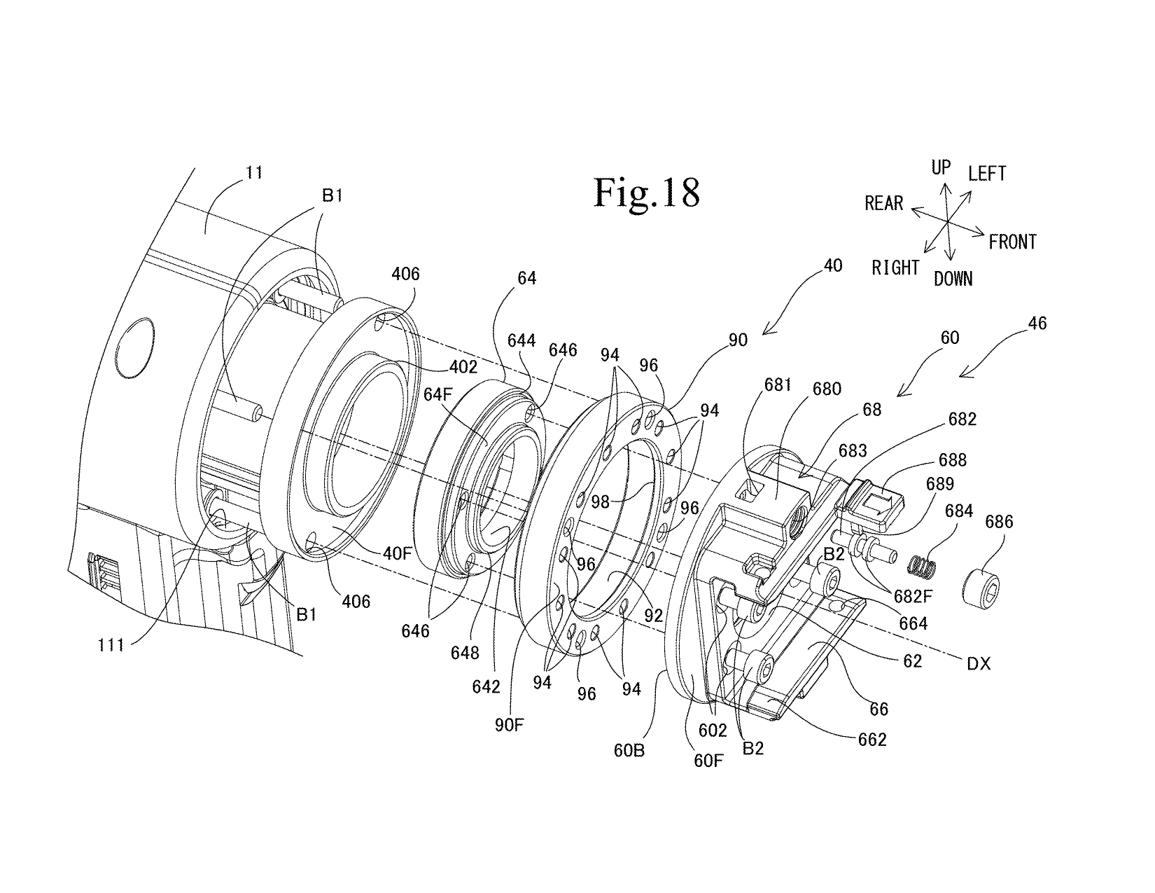

As shown in FIG. 18, the clamp mounting part 60 is rotatably mounted to a rotation locking part 90 of the main housing 40 of the flare forming device 30. A front part 40F of the main housing 40 has a generally annular shape and has a cylindrical part 402 and an opening(s) 406. The rotation locking part 90 is mounted to the front part 40F of the main housing 40 so as not to rotate.

The rotation locking part 90 has a generally annular shape having an opening 92 in the center. Pin housing (receiving) parts 94 for fixing (locking) the clamp mounting part 60 at a prescribed rotation angle, and a female thread part(s) 96 are formed in a front part 90F of the rotation locking part 90. The rotation locking part 90 is fixed to the front part 40F of the main housing 40 so as not to rotate, by a bolt B1 being inserted through the opening 406 of the front part 40F of the main housing 40 and threadedly engaged with the female thread part 96.

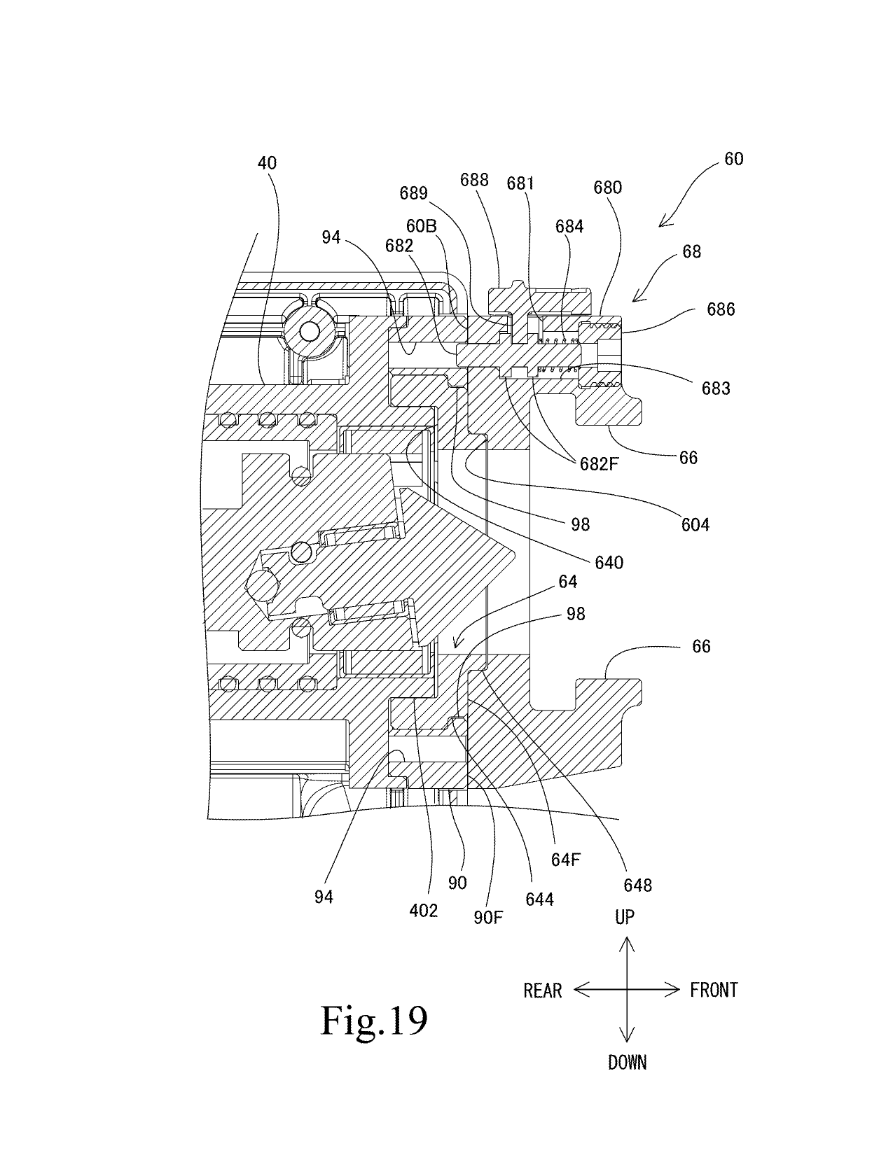

The clamp mounting part 60 is supported to rotate relative to the rotation locking part 90 by being connected to a support part 64. The support part 64 has a generally annular shape having an opening 642 in the center. A restriction part 644, a female thread part(s) 646 and a cylindrical part 648 are formed in a front part 64F of the support part 64. The support part 64 is fixed to a back part 60B of the clamp mounting part 60 so as not to rotate, by a bolt B2 being inserted through an opening 602 formed in the front part 60F of the clamp mounting part 60 and being threadedly engaged with the female thread part 646. As shown in FIG. 19, the cylindrical part 648 of the support part 64 protrudes forward of the front part 90F of the rotation locking part 90 and is engaged in a recess 604 formed in the back part 60B of the clamp mounting part 60.

As shown in FIG. 18, the restriction part 644 is recessed in a peripheral part of the front part 64F of the support part 64 and engaged with a projection 98 of the rotation locking part 90. The projection 98 protrudes radially inward from a peripheral part of a front end part of the opening 92. As shown in FIG. 19, the projection 98 is held between the restriction part 644 of the support part 64 and the back part 60B of the clamp mounting part 60. Thus, the clamp mounting part 60 and the support part 64 are rotatably held relative to the rotation locking part 90.

Further, a recess 640 is formed in a back part of the support part 64 and engaged in the cylindrical part 402 of the front part 40F of the main housing 40. Thus, the clamp mounting part 60 and the support part 64 are rotatably held relative to the main housing 40. In this manner, the rotation locking part 90 is fixed to the main housing 40 so as not to rotate, and the clamp mounting part 60 and the support part 64 are rotatably held relative to the main housing 40 and the rotation locking part 90.

As shown in FIG. 18, the clamp mounting part 60 has an angle setting mechanism 68 including an angle setting pin 682. The clamp mounting part 60 is fixed to the rotation locking part 90 and the main housing 40 at a prescribed rotation angle by the angle setting pin 682 being engaged in any of the pin housing parts 94 of the rotation locking part 90. The angle setting mechanism 68 includes a pin housing 680, the angle setting pin 682 and a releasing operation part 688.

As shown in FIG. 19, the angle setting pin 682 is a long shaft-like member. The angle setting pin 682 is housed in a through hole 683 of the pin housing 680 such that an axial direction of the angle setting pin 682 is parallel to the driving axis DX (to front-rear direction).

In this embodiment, as shown in FIG. 19, the angle setting pin 682 is covered by a cover part 686 after inserted into the through hole 683 of the pin housing 680 and housing the angle setting pin 682 into the pin housing 680 is completed. The cover part 686 is integrated with the pin housing 680 by threaded engagement with the pin housing 680.

The angle setting pin 682 is arranged in the through hole 683 of the pin housing 680 so as to move in the axial direction. Specifically, the angle setting pin 682 can be moved in the axial direction to be switched between a protruding position in which a tip of the angle setting pin 682 protrudes outside from the back part 60B of the clamp mounting part 60 and a housing position in which the tip of the angle setting pin 682 is housed in the pin housing 680. As shown in FIG. 19, the angle setting pin 682 in the protruding position is engaged in the pin housing part 94 of the rotation locking part 90.

A biasing member 684 is arranged around the angle setting pin 682. The angle setting pin 682 is a compression coil spring, and biases the angle setting pin 682 rearward from the pin housing 680. The angle setting pin 682 is restricted from moving in the axial direction by an inner wall of the pin housing 680, and normally biased by the biasing member 684 to be placed in the protruding position.

In this embodiment, the angle setting pin 682 has a pair of flanges 682F. The flanges 682F are parts having a larger diameter than the other part of the angle setting pin 682. The flanges 682F are arranged to face each other on the axis of the angle setting pin 682. A connection part 689 of the releasing operation part 688 is arranged between the flanges 682F.

The connection part 689 is inserted through the through hole 683 via an opening 681 formed in an outer surface of the pin housing 680, and connected to the angle setting pin 682 between the flanges 682F. When the releasing operation part 688 is moved in the front-rear direction, the connection part 689 biases the flanges 682F to move the angle setting pin 682 in the front-rear direction. Thus, the position of the angle setting pin 682 can be switched between the protruding position and the housing position by operating the releasing operation part 688. In this embodiment, with the presence of the biasing member 684, the user can move the angle setting pin 682 to the housing position by manually moving the releasing operation part 87 against the biasing force of the biasing member 684.

As shown in FIG. 19, when the clamp mounting part 60 is arranged at a prescribed rotation angle at which the pin housing part 683 is arranged, the angle setting pin 682 is moved to the protruding position by a restoring force of the biasing member 684. The angle setting pin 682 is engaged in the pin housing part 94 so that the clamp mounting part 60 is restricted from rotating relative to the main housing 40 and the rotation locking part 90.

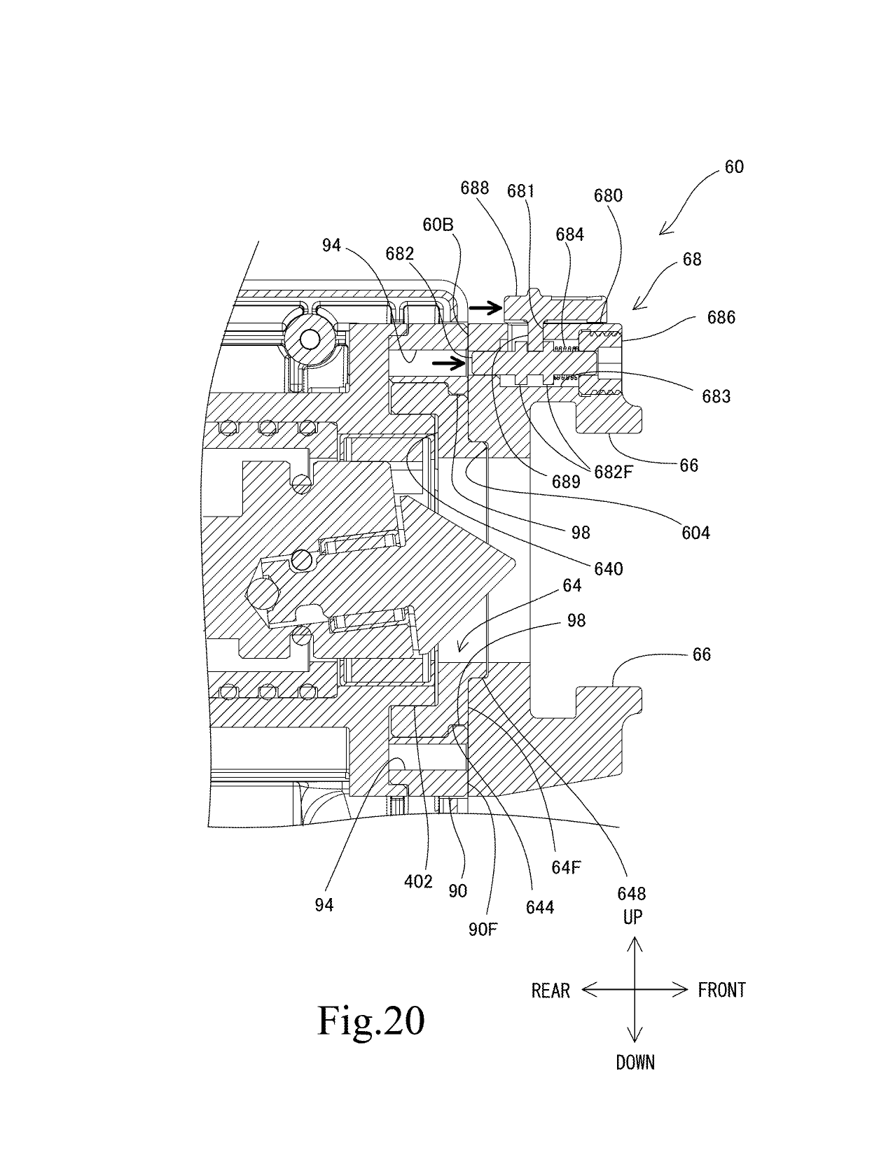

When the angle setting pin 682 is placed in the protruding position and engaged in the pin housing part 94, the releasing operation part 688 is placed at a rear end in a movable range. In order to change the rotation angle of the clamp mounting part 60, the releasing operation part 688 is manually slid forward. As shown in FIG. 20, when the releasing operation part 688 is slid forward, the angle setting pin 682 is moved from the protruding position to the housing position. Thus, the angle setting pin 682 is disengaged from the pin housing part 94. The user can change the rotation angle of the clamp mounting part 60 by rotating the clamp mounting part 60 while the releasing operation part 688 is slid forward.

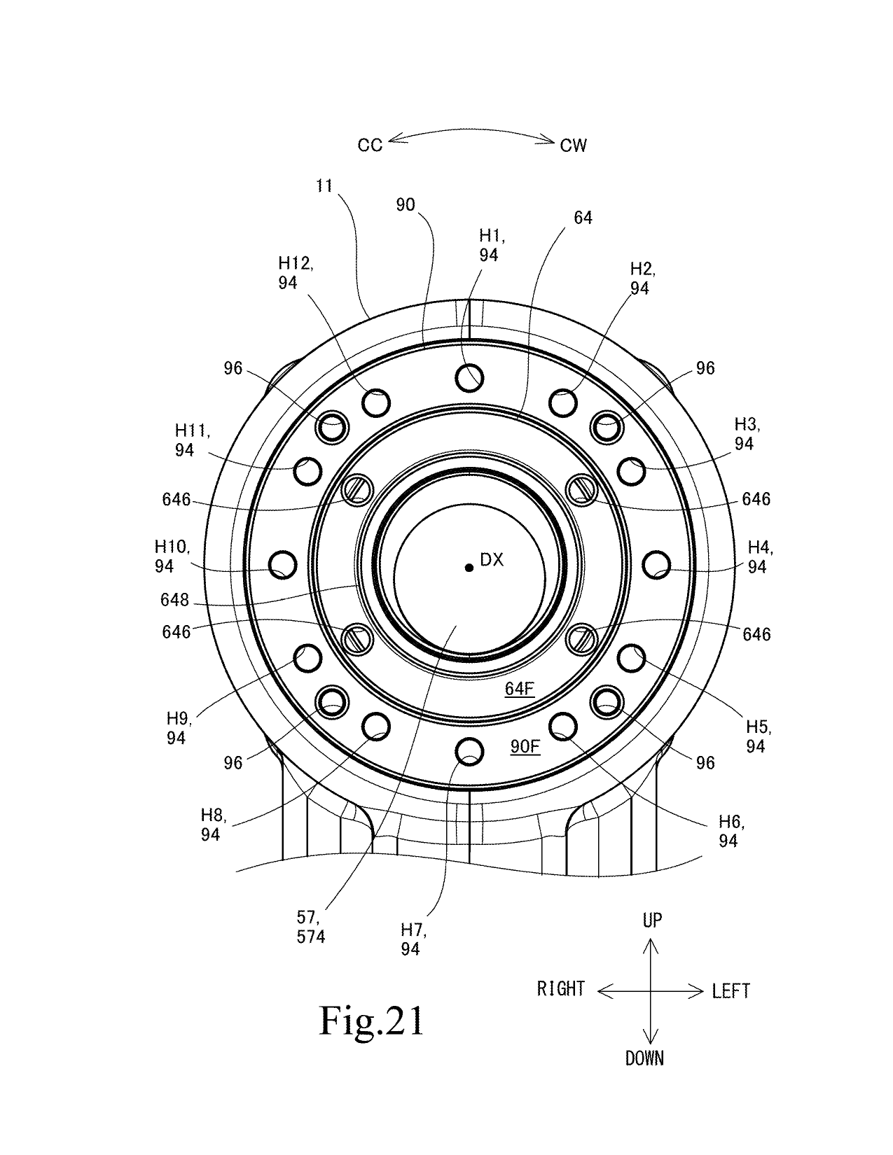

As shown in FIG. 21, the pin housing parts 94 are formed in a circumferential direction around the driving axis DX, in the front part 90F of the rotation locking part 90. The positions of the pin housing parts 94 relative to the driving axis DX define the rotation angles at which the clamp mounting part 60 can be fixed. In this embodiment, the pin housing parts 94 are arranged in twelve positions of the rotation angles H1 to H12 at 30 degree intervals as shown in FIG. 21. The rotation angle H1 is the first rotation angle shown in FIG. 17.

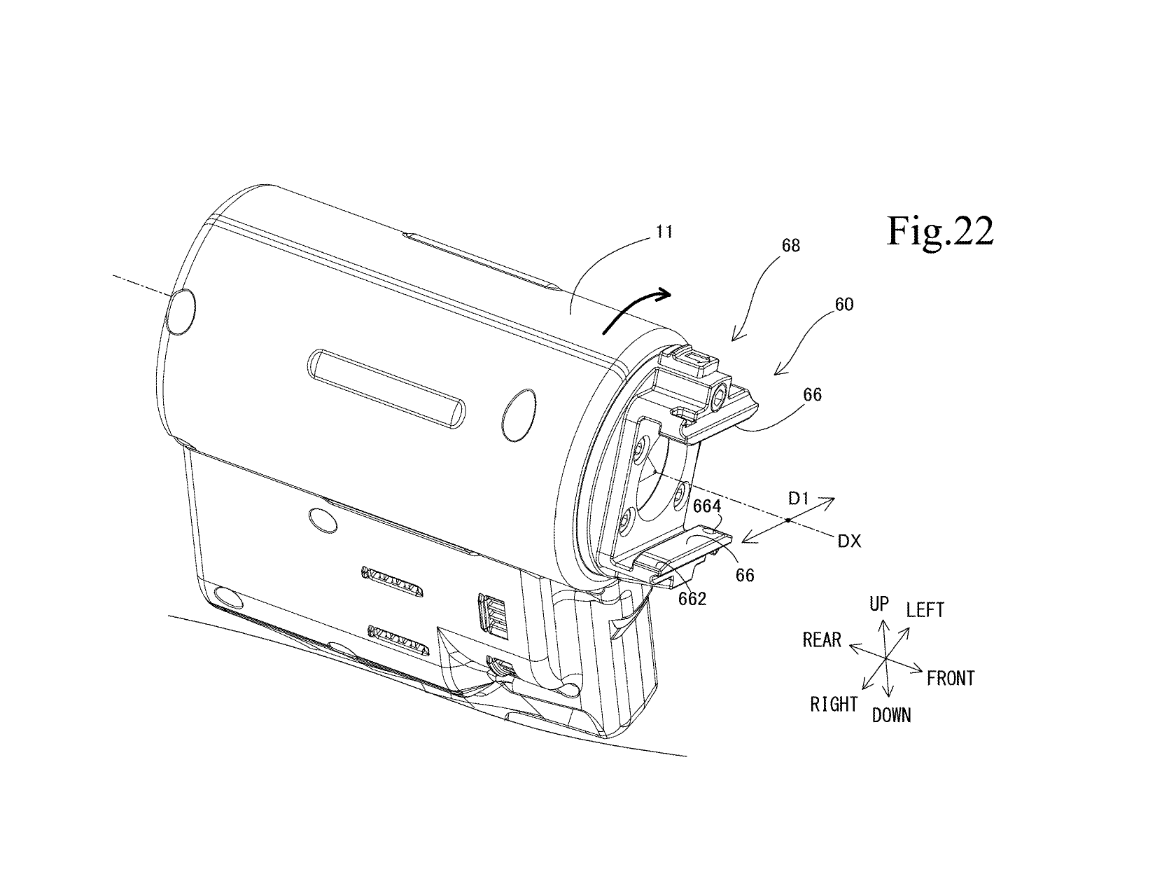

FIGS. 22 to 26 show how the clamp mounting part 60 is rotated relative to the rotation locking part 90. More specifically, FIGS. 22 to 26 show the clamp mounting part 60 rotated in a clockwise direction CW and fixed in the five pin housing parts 94, respectively, which are arranged in the positions corresponding to the rotation angles H2 to H6 at 30 degree intervals.

As shown in FIG. 21, in this embodiment, the inserting (mounting) direction D1 of mounting the clamping device 80 to the clamp mounting part 60 can be switched to twelve directions by rotating the clamp mounting part 60. Thus, the clamping device 80 can be mounted to the flare forming device 30 without substantially changing the orientation (attitude) of the flare forming device 30 relative to the clamping device 80 clamping the pipe P.

In the clamping device 80 of this embodiment, the both ends of the guide rails 66 are open. Thus, the clamping device 80 can be mounted to the clamp mounting part 60 from the twelve directions relative to the driving axis DX simply by rotating the clamp mounting part 60 to the six positions shown in FIG. 17 and FIGS. 22 to 26, without changing the direction (attitude) of the flare forming device 30.

As shown in FIG. 21, in this embodiment, the pin housing parts 94 are arranged, according to the extending direction of the grip part 150, in the positions including the positions of the rotation angles where the direction of inserting (mounting) the clamping device 80 to the clamp mounting part 60 corresponds to the up-down direction and the positions of the rotation angles where the inserting direction corresponds to the left-right direction. Specifically, the pin housing parts 94 are arranged in the positions including the positions of the rotation angle H1 on the upper side, the rotation angle H4 on the right side, the rotation angle H7 on the lower side, and the rotation angle H10 on the left side, relative to the driving axis DX. With this arrangement, the clamping device 80 can be inserted (mounted) to the clamp mounting part 60 in the up-down direction and the left-right direction. Thus, the user can easily mount the clamping device 80 to the clamp mounting part 60 while holding the grip part 150. Where, like in this embodiment, the both sides of the clamp mounting part 60 are open and the clamping device 80 can be mounted to the clamp mounting part 60 from the both sides of the clamp mounting part 60, the pin housing parts 94 in either of the positions of the rotation angles H1 and H7 and in either of the positions of the rotation angles H4 and H10 may be omitted. Even in this case, the clamping device 80 can be inserted (mounted) to the clamp mounting part 60 in the up-down direction and the left-right direction.

As shown in FIG. 21, in this embodiment, the clamp mounting part 60 can be rotated both in the clockwise direction CW and a counterclockwise direction CC around the driving axis DX when the main housing 40 is viewed from the front. Thus, the amount of rotation of the clamp mounting part 60 to an intended rotation angle can be (selectively) reduced.

In this embodiment, the clamp mounting part 60 is configured to repeatedly turn relative to the main housing 40 around the driving axis DX. Thus, the clamp mounting part 60 can be turned to a desired (intended) rotation angle in a more preferable manner than in a structure in which the number of rotation of the clamp mounting part 60 relative to the main housing 40 is restricted.

The number of the pin housing parts 94 can be freely set according to the intended rotation angle. Preferably, however, the pin housing parts 94 are arranged at least in a position of a freely set rotation angle (hereinafter referred to as a “reference rotation angle”) and a position of a rotation angle (hereinafter referred to as an “orthogonal rotation angle”) that is rotated 90 degrees from the position of the reference rotation angle. With this configuration, the clamping device 80 can be inserted (mounted) to the clamp mounting part 60 at least from the two directions orthogonal to each other. Thus, the clamping device 80 can be mounted without substantially changing the direction (attitude) of the flare forming device 30. Where, like in this embodiment, the both sides of the clamp mounting part 60 are open and the clamping device 80 can be mounted to the clamp mounting part 60 from the both sides of the clamp mounting part 60, the clamping device 80 can be mounted at least from the four directions around the clamp mounting part 60.

As described above, the clamping device 80 of this embodiment is configured to switch the first and second bodies 81, 83 between the closed position and the open position by the operating mechanism 84 utilizing the booster mechanism. Thus, with the clamping device 80 of this embodiment, the pipe P can be held with a large force by a simple operation utilizing the booster mechanism. The pipe P can be firmly held before the clamping device 80 is mounted to the flare forming device 30, so that the pipe P can be restrained or prevented from being displaced before the clamping device 80 is mounted to the flare forming device 30.

The flare forming device 30 of this embodiment has the pair of guide rails 66 that are configured to be engaged with the first groove 816 and the second groove 836 that are formed in the first side part 81T and the second side part 83T of the clamping device 80, respectively. The flare forming device 30 holds the clamping device 80 by engagement with the side parts of the clamping device 80. Therefore, the clamping device 80 can be mounted to the flare forming device 30 even if the flare forming device 30 has a member for mounting the clamping device 80 that does not extend forward of the clamping device 80. Therefore, the length of the flare forming device 30 in the front-rear direction can be shortened, and the flare forming device 30 can be formed smaller than a conventional one.

In the flare forming device 30 of this embodiment, the clamp mounting part 60 is configured to be rotated around the driving axis DX relative to the main housing 40 and fixed to the main housing 40 at the rotation angles. The clamping device 80 can be mounted to the clamp mounting part 60 without substantially changing the orientation (attitude) of the flare forming device 30 relative to the clamping device 80, by changing the rotation angle of the clamp mounting part 60 according to the inserting direction (orientation) of the clamping device 80. This helps reduce or minimize reduction of work efficiency in the operation of mounting the clamping device 80 in a narrow place.

### B. Other Embodiments:

In the above-described first embodiment, the flare forming tool 10 is described by way of example as a power tool exclusively for flaring operation and in which the flare forming device 30 is incorporated in the tool housing 11 together with the motor 21. The flare forming device 30 may however be configured as an attachment that can be attached to a known power tool (rotary tool) configured to rotationally drive a tool accessory around a driving axis. With this configuration, a user can attach the flare forming device 30 to the power tool at a desired time to use the power tool as a flare forming tool. Thus, the kinds of operations for which the power tool can be used are increased and the convenience of the power tool is improved.

The flare forming device 30 may be selectively attached to a rotary tool such as a driver drill, a drilling tool and a fastening tool (and used). The flare forming device 30 may be attached not to a power tool, but selectively to a manual tool having a connecting shaft that can be manually rotated, or may be integrated with such a manual tool to form a manual flare forming tool.

The flare forming tool 10 is an example of the “flare forming tool”. The flare forming device 30 and the clamp mounting part 60 are an example of the “flare forming device”. The clamping device 80 is an example of the “clamping device”. The first body 81, the second body 83 and the body 800 are examples of the “first body”, the “second body” and the “body”, respectively. The first connection part 841 is an example of the “first connection part”. The clamp hole 82 is an example of the “clamp hole”. The operating mechanism 84 is an example of the “operating mechanism”. The engagement hole 664 is an example of the “first engagement hole”. The positioning pin 88 is an example of the “positioning pin”. The first facing part 81S and the second facing part 83S are examples of the “first facing part” and the “second facing part”, respectively. The fixing pin 89 and the engagement hole 834 are examples of the “fixing pin” and the “second engagement hole”, respectively. The biasing member 882 is an example of the “biasing member”. The operation part 87 is an example of the “operation part”. The first link 846, the second link 848 and the second connection part 842 are examples of the “first link”, the “second link” and the “second connection part”, respectively. The operating mechanism 84 is an example of the “toggle mechanism”. The first groove 816 and the second groove 836 are examples of the “groove”. The guide rail 66 is an example of the “guide rail”. The extending direction D1 is an example of the “extending direction”. The pipe P is an example of the “pipe”.

The clamping device, the flare forming device and the flare forming tool according to the present disclosure are not limited to the clamping device 80, the flare forming device 30 and the flare forming tool 10 of the above-described embodiments. For example, the following non-limiting modifications may be made. At least one of these modifications can be adopted in combination with at least one of the features of the clamping device 80, the flare forming device 30 and the flare forming tool 10 of the above-described embodiment and the claimed invention.

(B1) In the above-described first embodiment, the booster mechanism is formed by a toggle mechanism, but the booster mechanism is not limited to the toggle mechanism. It may be other various mechanisms such as a cam, a lever, a crank and a link.

(B2) In the above-described first embodiment, the biasing member 882 is arranged around the positioning pin 88, but the biasing member 882 may be omitted. In this case, the positioning pin 88 is switched between the protruding position and the housing position by user’s manual operation of the operation part 87, including the operation of engaging the positioning pin 88 into the engagement hole 664.

(B3) In the above-described first embodiment, the first groove 816 is formed in the first side part 81T and the second groove 836 is formed in the second side part 83T, but the first groove 816 may be formed in a side part other than the first side 81T, in the left side part 81L and the right side part 81R. The second groove 836 may be formed in a side part other than the second side part 83T, in the left side part 83L and the right side part 83R.

The present disclosure is not limited to any of the above-described embodiments but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof.

### DESCRIPTION OF THE REFERENCE NUMERALS

5: main shaft, 6: feed screw mechanism, 7: clutch mechanism, 10: flare forming tool, 11: tool housing, 15: handle, 17: battery mounting part, 19: battery, 20: controller, 21: motor, 23: reduction mechanism, 30: flare forming device, 40: main housing, 40F: front part, 43: transmission shaft, 44: auxiliary spring, 46: housing, 51: sliding part, 52: front end part, 53: rear end part, 55: shaft part, 56: male thread part, 57: cone, 60: clamp mounting part, 60B: back part, 60F: front part, 62: opening, 64: support part, 64F: front part, 66: guide rail, 68: angle setting mechanism, 71: fixed sleeve, 73: movable flange, 75: pressure spring, 77: rotation stopper, 81: first body, 81B: back part, 81F: front part, 81L: left side part, 81R: right side part, 81S: first facing part, 81T: first side part, 82: clamp hole, 82T: tapered part, 83: second body, 83B: back part, 83F: front part, 83L: left side part, 83R: right side part, 83S: second facing part, 83T: second side part, 84: operating mechanism, 86: stopper, 86T: tip, 87: operation part, 88: positioning pin, 88T: tip, 89: fixing pin, 89T: tip, 90: rotation locking part, 90F: front part, 92: opening, 94: pin housing part, 96: female thread part, 98: projection, 111: opening, 150: grip part, 151: trigger, 153: switch, 212: output shaft, 233: output gear, 402: cylindrical part, 406: opening, 407: shoulder part, 431: bearing, 432: bearing, 510: bearing, 551: connecting hole, 571: cone part, 573: shaft part, 581: radial bearing, 602: opening, 604: recess, 640: recess, 642: opening, 644: restriction part, 646: female thread part, 648: cylindrical part, 662: pressing part, 662C: second part, 662E: first part, 664: engagement hole, 680: pin housing, 681: opening, 682: angle setting pin, 682F: flange, 683: through hole, 684: biasing member, 686: cover part, 688: releasing operation part, 689: connection part, 711: first sleeve, 715: second sleeve, 734: clutch pin, 737: female thread part, 781: thrust bearing, 785: washer, 800: body, 811: first recess, 816: first groove, 832: second recess, 834: engagement hole, 836: second groove, 841: first connection part, 842: second connection part, 843: third connection part, 844: fourth connection part, 845: lever, 846: first link, 848: second link, 872: connection part, 882: biasing member, 884: flange, 886: cover part, B1, B2: bolt, DX: driving axis, P: pipe

1. A clamping device that is configured to be mounted to a flare forming device, comprising:
a body including a first body and a second body;
a first connection part that rotatably connects the first body and the second body to each other; and
an operating mechanism that is rotatably connected to the first body and rotatably connected to the second body, and configured to switch the first body and the second body, by utilizing a booster mechanism, between a closed position in which the first body and the second body are close to each other and form a clamp hole in the body, and an open position in which the first body and the second body are apart from each other.

2. The clamping device as defined in claim 1, wherein:
the first body includes a positioning pin that is configured to be engaged in a first engagement hole formed in the flare forming device; and
the positioning pin is configured to be moved inside the first body to be switched between a protruding position in which the positioning pin protrudes outside of the first body and is configured to be engaged in the first engagement hole, and a housing position in which the positioning pin is housed in the first body.

3. The clamping device as defined in claim 2, wherein:
the first body further includes a first facing part that faces the second body in the closed position, and a fixing pin that protrudes outside from the first facing part;
the second body includes a second facing part that faces the first facing part in the closed position, and a second engagement hole that is formed in the second facing part and is configured to be engaged with the fixing pin in the closed position; and
the fixing pin is integrated with the positioning pin.

4. The clamping device as defined in claim 2, further comprising:
a biasing member that biases the positioning pin toward the protruding position from the housing position;
wherein:
the positioning pin is switched from the housing position to the protruding position and engaged in the first engagement hole by being biased by the biasing member when the clamping device is placed in a fixed position of the flare forming device; and
the clamping device is fixed in the fixed position by the positioning pin engaged in the first engagement hole.

5. The clamping device as defined in claim 2, further comprising an operation part that is connected to the positioning pin and configured to move the positioning pin to be switched between the protruding position and the housing position.

6. The clamping device as defined in claim 1, wherein:
the operating mechanism includes:
a first link that is connected to the first body to rotate;
a second link that is connected to the second body to rotate; and
a second connection part that connects the first link and the second link to rotate relative to each other; and
the booster mechanism comprises a toggle mechanism including the first connection part, the first link, the second link and the second connection part.

7. The clamping device as defined in claim 1, wherein:
at least one of the first body and the second body has a linearly extending groove; and
the groove is configured to be engaged with a guide rail provided on the flare forming device.

8. The clamping device as defined in claim 7, wherein:
the first body includes a positioning pin that is configured to be engaged in a first engagement hole formed in the flare forming device, and the groove; and
the positioning pin is:
provided in the groove of the first body;
configured to be moved inside the first body to be switched between a protruding position in which the positioning pin protrudes outside from the first body and is configured to be engaged in the first engagement hole, and a housing position in which the positioning pin is housed in the first body; and
configured to be engaged in the first engagement hole formed in the guide rail of the flare forming device.

9. The clamping device as defined in claim 7, wherein:
the first body includes a positioning pin that is configured to be engaged in a first engagement hole formed in the flare forming device; and
the positioning pin is:
configured to be moved inside the first body to be switched between a protruding position in which the positioning pin protrudes outside from the first body and is configured to be engaged in the first engagement hole, and a housing position in which the positioning pin is housed in the first body; and
configured to be switched between the protruding position and the housing position by moving in a direction crossing an extending direction of the groove inside the first body.

10. The clamping device as defined in claim 4, further comprising an operation part that is connected to the positioning pin and configured to move the positioning pin to be switched between the protruding position and the housing position.

11. The clamping device as defined in claim 10, wherein:
at least one of the first body and the second body has a linearly extending groove; and
the groove is configured to be engaged with a guide rail provided on the flare forming device.

12. The clamping device as defined in claim 11, wherein:
the first body includes a positioning pin that is configured to be engaged in a first engagement hole formed in the flare forming device, and the groove; and
the positioning pin is:
provided in the groove of the first body;
configured to be moved inside the first body to be switched between a protruding position in which the positioning pin protrudes outside from the first body and is configured to be engaged in the first engagement hole, and a housing position in which the positioning pin is housed in the first body; and
configured to be engaged in the first engagement hole formed in the guide rail of the flare forming device.

13. The clamping device as defined in claim 12, wherein:
the first body includes a positioning pin that is configured to be engaged in a first engagement hole formed in the flare forming device; and
the positioning pin is:
configured to be moved inside the first body to be switched between a protruding position in which the positioning pin protrudes outside from the first body and is configured to be engaged in the first engagement hole, and a housing position in which the positioning pin is housed in the first body; and
configured to be switched between the protruding position and the housing position by moving in a direction crossing an extending direction of the groove inside the first body.

14. The clamping device as defined in claim 13, wherein:
the first body further includes a first facing part that faces the second body in the closed position, and a fixing pin that protrudes outside from the first facing part;
the second body includes a second facing part that faces the first facing part in the closed position, and a second engagement hole that is formed in the second facing part and is configured to be engaged with the fixing pin in the closed position; and
the fixing pin is integrated with the positioning pin.

15. An electric flare forming tool, comprising:
a flare forming device that forms a flare at an end of a pipe; and
a clamping device as defined in claim 1.
